(19) United States
(12) Patent Application Publication
(10) Pub. No.: US 2007/0240072 A1
(43) Pub. Date: Oct. 11, 2007

(54) User interface for editing media assests

(75) Inventors: Ryan B. Cunningham, San Francisco, CA (US); Michael G. Folgner, San Francisco, CA (US); Ashot A. Petrosian, San Francisco, CA (US); Stephen B. Weibel, San Francisco, CA (US)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/786,016

(22) Filed: Apr. 9, 2007

Related U.S. Application Data
(60) Provisional application No. 60/790,569, filed on Apr. 10, 2006.

(51) Int. Cl. G06F 3/048; G06F 3/00; G06F 17/00

(52) U.S. Cl. 715/764; 715/716; 715/730; 715/530

(57) ABSTRACT

An interface for editing media assets is provided. The interface includes a display for displaying a plurality of tiles, each tile associated with a media asset, and a timeline for displaying relative times of each of the plurality of media assets as edited by a user for an aggregate media asset. The timeline display automatically adjusts in response to edits to the media assets; in one example, the timeline concatenating in response to an edit or change in the media assets selected for the aggregate media asset (e.g., in response to the addition, deletion, or edit of a selected media asset). Additionally, in some examples, the timeline maintains a fixed length when adjusting in response to edits to the media assets. In another example, the interface includes a search interface for searching for media assets from remote or local sources.

### RELATED APPLICATIONS

This application claims benefit of U.S. Provisional Application No. 60/790,569, filed Apr. 10, 2006, which is hereby incorporated by reference herein in its entirety. The present application is further related to U.S. application Ser. Nos. 11/622,920, 11/622,938, 11/622,948, 11/622,957, 11/622,962, and 11/622,968, all of which were filed on Jan. 12, 2007, and all of which are hereby incorporated by reference herein in their entirety.

### BACKGROUND

1. Field

The present invention relates generally to systems and methods for the editing and generation of media assets such as video and/or audio assets via a network, such as the Internet or an intranet, and in particular, to a user interface and method for editing media assets including a concatenating timeline and a search interface.

2. Description of Related Art

Currently there exist many different types of media assets in the form of digital files that are transmitted via the Internet. Digital files may contain data representing one or more types of content, including but not limited to, audio, images, and videos. For example, media assets include file formats such as MPEG-1 Audio Layer 3 (“MP3”) for audio, Joint Photographic Experts Group (“JPEG”) for images, Motion Picture Experts Group (“MPEG-2” and “MPEG-4”) for video, Adobe Flash for animations, and executable files.

Such media assets are currently created and edited using applications executing locally on a dedicated computer. For example, in the case of digital video, popular applications for creating and editing media assets include Apple's iMovie and FinalCut Pro and Microsoft's MovieMaker. After creation and editing a media asset, one or more files may be transmitted to a computer (e.g., a server) located on a distributed network such as the Internet. The server may host the files for viewing by different users. Examples of companies operating such servers are YouTube (http://youtube.com) and Google Video (http://video.google.com).

Presently, users must create and/or edit media assets on their client computers before transmitting the media assets to a server. Many users are therefore unable able to edit media assets from another client where, for example, the user's client computer does not contain the appropriate application or media asset for editing. Moreover, editing applications are typically designed for professional or high-end consumer markets. Such applications do not address the needs of average consumers who lack dedicated computers with considerable processing power and/or storage capacity.

Additionally, average consumers typically do not have the transmission bandwidth necessary to transfer, share or access media assets that may be widespread across a network. Increasingly, many media assets are stored on computer connected to the Internet. For example, services such as Getty Images sell media assets (e.g., images) that are stored on computers connected to the Internet. Thus, when a user requests a media asset for manipulation or editing, the asset is typically transferred in its entirety over the network. Particularly in the case of digital video, such transfers may consume tremendous processing and transmission resources.

### SUMMARY

According to one aspect and one example of the present invention, an interface for editing and generating media assets is provided. In one example, the interface includes a dynamic timeline that concatenates automatically in response to user edits. Further, the interface may facilitate editing media assets in an on-line client-server architecture, wherein a user may search for and select media assets via the interface for editing and media generation.

In one example, the interface includes a display for displaying a plurality of tiles, each tile associated with a media asset, and a timeline for displaying relative times of each of the plurality of media assets as edited by a user for an aggregate media asset. The timeline display automatically adjusts in response to edits to the media assets; in one example, the timeline concatenating in response to an edit or change in the media assets selected for the aggregate media asset (e.g., in response to the addition, deletion, or edit of a selected media asset). Additionally, in some examples, the timeline maintains a fixed length when adjusting in response to edits to the media assets. The interface may further include an aggregate media asset display portion for displaying the media assets according to the edit instruction.

In another example, the interface includes a search interface for searching for media assets. For example, the interface may include a tile display for displaying a plurality of tiles, each tile associated with a media asset for use in an aggregate media asset, a display for displaying the media assets associated with the plurality of tiles, and a search interface for searching for additional media assets. The search interface may operate to search remote media assets, e.g., associated with remote storage libraries, sources accessible via the Internet, locally stored or originated, and so on. A user may select or “grab” media assets from the search interface and add them to an associated local or remote storage associated with the user for editing. Additionally, new tiles may be displayed in the tile display portion of the interface as media assets are selected.

According to another aspect of the present invention, a method for editing media assets and generating an aggregate media asset is provided. In one example, the method comprises displaying a timeline indicating relative times of a plurality of media assets as edited for an aggregate media asset, and adjusting the display of the timeline in response to changes to the edits of the media assets. In one example, the method includes concatenating the timeline in response to an edit or change in the media assets selected for the aggregate media asset (e.g., in response to the addition, deletion, or time of a selected media asset). In another example, the timeline maintains a fixed length when adjusting in response to edits to the media assets. The method may further include displaying an aggregate media asset according to the edits.

According to another aspect of the present invention, a computer-readable medium comprising instructions for editing media assets and generating an aggregate media asset is provided. In one example, the instructions are for causing the performance of a method including displaying a timeline indicating relative times of a plurality of media assets as edited for an aggregate media asset, and adjusting the display of the timeline in response to changes to the edits of the media assets. In one example, the instructions further cause concatenating of the timeline in response to an edit or change in the media assets selected for the aggregate media asset (e.g., in response to the addition, deletion, or time of a selected media asset). In another example, the timeline maintains a fixed length when adjusting in response to edits to the media assets. The instructions may further include causing the display of an aggregate media asset according to the edits.

According to another aspect and one example of the present invention, apparatus for client-side editing of media assets in a client-server architecture is provided. In one example, a user of a client device uses an editor to edit local and remote media assets in an on-line environment (e.g., via a web browser), where media assets originating locally may be edited without delays for uploading the media assets to a remote storage system.

In one example, the apparatus includes logic (e.g., software) for generating an edit instruction in response to user input, the edit instruction associated with a media asset stored locally, and upload logic for transmitting at least a portion of the media asset to a remote storage subsequent to selecting the local media asset for editing, e.g., subsequent to the generation of the edit instruction. The portion of the media asset transmitted to the remote storage may be based on the edit instruction, and in one example, only the portion being edited according to the edit instruction is transmitted to the remote storage.

In one example, the media asset is transmitted in the background of an editing interface. In other examples, the media asset is not transmitted until a user indicates they are done editing (e.g., selecting “save” or “publish”). The apparatus may further operate to transmit the edit instruction to a remote device such as a server associated with a remote editor or service provider. The edit instruction may further reference one or more remotely located media assets.

In another example, apparatus for editing media assets may include logic for receiving a first low-resolution media asset in response to a request to edit a first high-resolution media asset, the first high-resolution asset located remotely, generating an edit instruction in response to user input, the edit instruction associated with the first low-resolution media asset and a second media asset, the second media asset stored locally, and transmitting at least a portion of the second media asset to a remote storage. The portion of the second media asset transmitted may be based on the generated edit instruction. Further, the second media asset may be transmitted in the background.

In one example, the apparatus further comprises transmitting the edit instruction to a server associated with the remote storage, wherein the server renders an aggregate media asset based on the first high-resolution media asset and the transmitted second media asset. In another example, the apparatus receives the first high resolution media asset and renders an aggregate media asset based on the first high-resolution media asset and the second media asset.

According to another aspect of the present invention, a method for client-side editing of media assets is provided. In one example, the method includes generating an edit instruction in response to user input, the edit instruction associated with a media asset stored locally, and transmitting (e.g., in the background) at least a portion of the media asset to a remote storage subsequent to the generation of the edit instruction, the portion of the media asset based on the edit instruction. The method may further include receiving a second low-resolution media asset associated with a second high-resolution media asset located remotely, the edit instruction associated with both the media asset stored locally and the second low-resolution media asset.

According to another aspect of the present invention, a computer-readable medium comprising instructions for client-side editing of media assets is provided. In one example the instructions are for causing the performance of the method including generating an edit instruction in response to user input, the edit instruction associated with a media asset stored locally, and transmitting at least a portion of the media asset to a remote storage subsequent to initiating the generation of the edit instruction, the portion of the media asset based on the edit instruction.

According to another aspect and one example of the present invention, apparatus for generating media assets based on user activity data is provided. In one example, the apparatus comprises logic for receiving data (e.g., edit instructions, user views, ranking, etc.) from a plurality of users, the data indicating a selection of at least one media asset from each of a plurality of sets of media assets for use in an aggregate media asset, and logic for causing the generation of an aggregate media asset or edit instructions based on the received data. Each set of media assets may correspond to a separate time or scene for inclusion in a larger media asset; for example, a set of clips to be used for a particular scene of an aggregate video or movie. The apparatus may further comprise logic for generating a ranking of media assets within each set of media assets based on data associated with a plurality of users (the ranking may be used to generate an aggregate movie or provide a user with editing suggestions).

In another example, apparatus for generating a media asset includes logic for receiving activity data from a plurality of users, the activity data associated with at least one media asset, and logic for causing a transmission of at least one (i.e., one or both) of an edit instruction or a media asset based on the received activity data. The apparatus may further generate at least one of the edit instructions or the media asset based on the received activity data.

The activity data may include edit instructions associated with at least one media asset. In one example, the activity data includes edit data associated with a first media asset, the edit data including a start edit time and an end edit time associated with the first media asset based on aggregate data from a plurality of user edit instructions associated with the media asset. In one example, the apparatus includes logic for generating a timeline displaying aggregate edit times of the first media asset based on the user activity data.

In other examples, the activity data may include or be leveraged to provide affinity data indicating affinities between the first media asset and at least a second media asset. For example, the activity data may indicate that a first media asset and a second media asset are commonly used in aggregate media assets, are commonly used adjacent each other in aggregate media assets, and so on. Such affinities may be determined from the number of edit instructions identifying the first media asset and the second media asset, as well as the proximity of the first media asset and the second media asset in the edit instructions. Affinity data may further include affinities based on users, communities, rankings, and the like. Various methods and algorithms for determining affinity based on collected user activity data are contemplated.

According to another aspect of the present invention, a method for editing and generating a media asset is provided. In one example, the method comprises receiving data (e.g., edit instructions, user views, ranking, etc.) from a plurality of users, the data indicating a selection of at least one media asset from each of a plurality of sets of media assets for use in an aggregate media asset, and generating an aggregate media asset based on the received data. Each set may correspond to a separate scene or clip for use in an aggregate media asset, e.g., a video or movie.

In another example, a method comprises receiving activity data from a plurality of users, the activity data associated with at least one media asset, and causing transmission of at least one of an edit instruction or a media asset based on the received activity data. The method may further comprise generating a media asset or edit instruction based on the received activity data. The activity data may comprise edit instructions associated with the at least one media asset, e.g., edit start and end times from aggregate user edit instructions. Further, various affinities may be generated from the aggregate activity data, including affinities between media assets, to other users, communities, and so on.

According to another aspect of the present invention, a computer-readable medium comprising instructions for editing media assets and generating an aggregate media asset is provided. In one example the instructions are for causing the performance of a method including receiving data from a plurality of users, the data associated with a selection of at least one media asset from each of a plurality of sets of media assets for use in an aggregate media asset, and generating an aggregate media asset based on the received data.

According to another aspect and one example of the present invention, apparatus for generating media assets based on context is provided. In one example, the apparatus comprises logic for causing the display of a suggestion for a media asset to a user based on context, logic for receiving at least one media asset, and logic for receiving an edit instruction associated with the at least one media asset. The context may be derived from user input or activity (e.g., in response to inquiries or associated websites where an editor is launched from), user profile information such as community or group associations, and so on. Additionally, context may include objectives of the user such as generating a topic specific video, e.g., a dating video, wedding video, real estate video, music video, or the like.

In one example, the apparatus further comprises logic for causing the display of questions or suggestion according to a template or storyboard to assist a user with generating a media asset. The logic may operate to prompt the user with questions or suggestions for particular media assets (and/or edit instructions) to be used in a particular order depending on the context.

The apparatus may further comprise logic for causing the transmission of at least one media asset to a remote device based on the context. For example, if the apparatus determines the user is creating a dating video, a particular set of media assets including video clips, music, effects, etc., that are associated with dating videos may be presented or populated to the user's editor for use in generating a media asset. In another example, the apparatus may determine a user is from San Francisco and supply media assets associated with San Francisco, Calif., and so on. The particular media assets selected may include a default set of media assets based on context, in other examples, the media assets may be determined based on affinity to the user and selected media assets.

According to another aspect of the present invention, a method for editing and generating a media asset is provided. In one example, the method comprises causing the display of a suggestion for generating an aggregate media asset to a user based on context associated with the user, receiving at least one media asset associated with the aggregate media asset, and receiving an edit instruction associated with the aggregate media asset.

According to another aspect of the present invention, a computer-readable medium comprising instructions for editing media assets and generating an aggregate media asset is provided. In one example the instructions are for causing the performance of a method including causing the display of a suggestion for generating an aggregate media asset to a user based on context associated with the user, receiving at least one media asset associated with the aggregate media asset, and receiving an edit instruction associated with the aggregate media asset.

The present invention and its various aspects are better understood upon consideration of the detailed description below in conjunction with the accompanying drawings and claims.

### BRIEF DESCRIPTION OF THE DRAWINGS

The following drawing figures, which form a part of this application, are illustrative of embodiments, systems, and methods described below and are not meant to limit the scope of the invention in any manner, which scope shall be based on the claims appended hereto.

FIG. 1 illustrates an embodiment of a system for manipulating a media asset in a networked computing environment.

FIGS. 2A and 2B illustrate embodiments of a system for manipulating a media asset in a networked computing environment.

FIGS. 3A and 3B illustrate embodiments of a method for editing a low-resolution media asset to generate a high-resolution edited media asset.

FIG. 4 illustrates an embodiment of a method for generating a media asset.

FIG. 5 illustrates an embodiment of a method for generating a media asset.

FIG. 6 illustrates an embodiment of a method for generating a media asset.

FIG. 7 illustrates an embodiment of a method for recording edits to media content.

FIG. 8 illustrates an embodiment of a method for identifying edit information of a media asset.

FIG. 9 illustrates an embodiment of a method for rendering a media asset.

FIG. 10 illustrates an embodiment of a method for storing an aggregate media asset.

FIG. 11 illustrates an embodiment of a method for editing an aggregate media asset.

FIGS. 12A and 12B illustrate embodiments of a user interface for editing media assets.

FIGS. 13A-13E illustrate embodiments of a timeline included with an interface for editing media assets.

FIGS. 14A-14C illustrate embodiments of a timeline and effects included with an interface for editing media assets.

FIG. 15 illustrates an embodiment of data generated from aggregate user activity data.

FIG. 16 illustrates an embodiment of a timeline generated based on aggregate user data.

FIG. 17 illustrates an embodiment of a timeline generated based on aggregate user data.

FIG. 18 illustrates conceptually an embodiment of a method for generating an aggregate media asset from a plurality of sets of media assets based on user activity data.

FIG. 19 illustrates an embodiment of a method for generating a media asset based on context.

FIG. 20 illustrates conceptually an embodiment of a method for generating an aggregate media asset based on context.

FIG. 21 illustrates an exemplary computing system that may be employed to implement processing functionality for various aspects of the invention.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

According to one aspect and example of the present invention, a client editor application is provided. The client editor application may provide for the uploading, transcoding, clipping, and editing of media assets within a client and server architecture. The editor application may provide the ability to optimize the user experience by editing files, e.g., media assets, originating from the client on the client device and files originating from (or residing with) the server on the server. A user may thereby edit media asset originating locally without waiting for the media asset to be transmitted (e.g., uploaded) to a remote server. Further, in one example the client editor application transmits only a portion of the media asset specified by an associated edit instruction, thereby further reducing transmission times and remote storage requirements.

According to another aspect and example of the present invention, a user interface for viewing, editing, and generating media assets is provided. In one example, the user interface includes a timeline associated with a plurality of media assets for use in generating an aggregate media asset, where the timeline concatenates in response to changes in the aggregate media asset (e.g., in response to deletions, additions, or edits to the media assets of the aggregate media asset). Additionally, in one example, the user interface includes a search interface for searching and retrieving media assets. For example, a user may search remote sources for media assets and “grab” media assets for editing.

According to another aspect and example of the present invention, apparatus for generating an object in response to aggregate user data is provided. For example, objects may be generated automatically based on activity data of a plurality of users (e.g., user inputs, views/selections by users, edits to media assets, edit instructions, etc.) related to one or more media assets. In one example, the generated object includes a media asset; in another example, the object includes a timeline indicating portions edited by other users; in another example, the object includes information or data regarding edits to particular media assets such as the placement within aggregate media assets, affinities to other media assets and/or users, edits thereto, and so on.

According to one aspect and example of the present invention, apparatus for providing suggestions to a user for creating a media asset is provided. In one example, the apparatus causes the display of suggestions for media assets to a user based on context associated with the user. For example, if the user is generating a dating video the apparatus provides suggestions, for example, via a template or storyboard, for generating the dating video. Other examples include editing wedding videos, real estate listings, music videos, and the like. The context may be derived from user input or activity (e.g., in response to inquiries, associated websites where an editor is launched from), user profile information such as community or group associations, and so on.

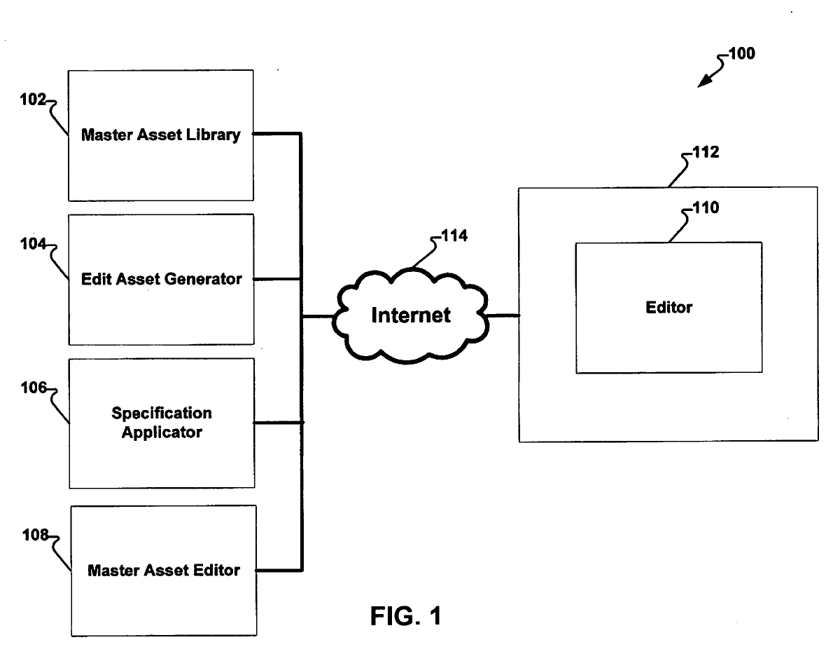

With respect initially to FIG. 1, an exemplary architecture and process for the various examples will be described. Specifically, FIG. 1 illustrates an embodiment of a system 100 for generating a media asset. In one embodiment, a system 100 is comprised of a master asset library 102. In one embodiment, a master asset library 102 may be a logical grouping of data, including but not limited to high-resolution and low-resolution media assets. In another embodiment, a master asset library 102 may be a physical grouping of data, including but not limited to high-resolution and low-resolution media assets. In an embodiment, a master asset library 102 may be comprised of one or more databases and reside on one or more servers. In one embodiment, master asset library 102 may be comprised of a plurality of libraries, including public, private, and shared libraries. In one embodiment, a master asset library 102 may be organized into a searchable library. In another embodiment, the one or more servers comprising master asset library 102 may include connections to one or more storage devices for storing digital files.

For purposes of this disclosure, the drawings associated with this disclosure, and the appended claims, the term “files” generally refers to a collection of information that is stored as a unit and that, among other things, may be retrieved, modified, stored, deleted or transferred. Storage devices may include, but are not limited to, volatile memory (e.g., RAM, DRAM), non-volatile memory (e.g., ROM, EPROM, flash memory), and devices such as hard disk drives and optical drives. Storage devices may store information redundantly. Storage devices may also be connected in parallel, in a series, or in some other connection configuration. As set forth in the present embodiment, one or more assets may reside within a master asset library 102.

For purposes of this disclosure, the drawings associated with this disclosure, and the appended claims, an “asset” refers to a logical collection of content that may be comprised within one or more files. For example, an asset may be comprised of a single file (e.g., an MPEG video file) that contains images (e.g., a still frame of video), audio, and video information. As another example, an asset may be comprised of a file (e.g., a JPEG image file) or a collection of files (e.g., JPEG image files) that may be used with other media assets or collectively to render an animation or video. As yet another example, an asset may also comprise an executable file (e.g., an executable vector graphics file, such as an SWF file or an FLA file). A master asset library 102 may include many types of assets, including but not limited to, video, images, animations, text, executable files, and audio. In one embodiment, master asset library 102 may include one or more high-resolution master assets. For the remainder of this disclosure, “master asset” will be disclosed as a digital file containing video content. One skilled in the art will recognize, however, that a master asset is not limited to containing video information, and as set forth previously, a master asset may contain many types of information including but not limited to images, audio, text, executable files, and/or animations.

In one embodiment, a media asset may be stored in a master asset library 102 so as to preserve the quality of the media asset. For example, in the case of a media asset comprising video information, two important aspects of video quality are spatial resolution and temporal resolution. Spatial resolution generally describes the clarity of lack of blurring in a displayed image, while temporal resolution generally describes the smoothness of motion. Motion video, like film, consists of a certain number of frames per second to represent motion in the scene. Typically, the first step in digitizing video is to partition each frame into a large number of picture elements, or pixels or pels for short. The larger the number of pixels, the higher the spatial resolution. Similarly, the more frames per second, the higher the temporal resolution.

In one embodiment, a media asset may be stored in a master asset library 102 as a master asset that is not directly manipulated. For example, a media asset may be preserved in a master asset library 102 in its original form, although it may still be used to create copies or derivative media assets (e.g., low-resolution assets). In one embodiment, a media asset may also be stored in a master asset library 102 with corresponding or associated assets. In one embodiment, a media asset stored in a master asset library 102 may be stored as multiple versions of the same media asset. For example, multiple versions of a media asset stored in master asset library 102 may include an all-keyframe version that does not take advantage of intra-frame similarities for compression purposes, and an optimized version that does take advantage of intra-frame similarities. In one embodiment, the original media asset may represent an all-keyframe version. In another embodiment, the original media asset may originally be in the form of an optimized version or stored as an optimized version. One skilled in the art will recognize that media assets may take many forms within a master asset library 102 that are within the scope of this disclosure.

In one embodiment, a system 100 is also comprised of an edit asset generator 104. In an embodiment, an edit asset generator 104 may be comprised of transcoding hardware and/or software that, among other things, may convert a media asset from one format into another format. For example, a transcoder may be used to convert an MPEG file into a Quicktime file. As another example, a transcoder may be used to convert a JPEG file into a bitmap (e.g., *.BMP) file. As yet another example, a transcoder may standardize media asset formats into a Flash video file (*.FLV) format. In one embodiment, a transcoder may create more than one versions of an original media asset. For example, upon receiving an original media asset, a transcoder may convert the original media asset into a high-resolution version and a low-resolution version. As another example, a transcoder may convert an original media asset into one or more files. In one embodiment, a transcoder may exist on a remote computing device. In another embodiment, a transcoder may exist on one or more connected computers. In one embodiment, an edit asset generator 104 may also be comprised of hardware and/or software for transferring and/or uploading media assets to one or more computers. In another embodiment, an edit asset generator 104 may be comprised of or connected to hardware and/or software used to capture media assets from external sources such as a digital camera.

In one embodiment, an edit asset generator 104 may generate a low-resolution version of a high-resolution media asset stored in a master asset library 102. In another embodiment, an edit asset generator 104 may transmit a low-resolution version of a media asset stored in a master asset library 102, for example, by converting the media asset in real-time and transmitting the media asset as a stream to a remote computing device. In another embodiment, an edit asset generator 104 may generate a low quality version of another media asset (e.g., a master asset), such that the low quality version preserves while still providing sufficient data to enable a user to apply edits to the low quality version.

In one embodiment, a system 100 may also be comprised of a specification applicator 106. In one embodiment, a specification applicator 106 may be comprised of one or more files or edit specifications that include edit instructions for editing and modifying a media asset (e.g., a high-resolution media asset). In one embodiment, a specification applicator 106 may include one or more edit specifications that comprise modification instructions for a high-resolution media asset based upon edits made to a corresponding or associated low-resolution media asset. In one embodiment, a specification applicator 106 may store a plurality of edit specifications in one or more libraries.

In one embodiment, a system 100 is also comprised of a master asset editor 108 that may apply one or more edit specifications to a media asset. For example, a master asset editor 108 may apply an edit specification stored in a specification applicator 106 library to a first high-resolution media asset and thereby creates another high-resolution media asset, e.g., a second high-resolution media asset. In one embodiment, a master asset editor 108 may apply an edit specification to a media asset in real-time. For example, a master asset editor 108 may modify a media asset as the media asset is transmitted to another location. In another embodiment, a master asset editor 108 may apply an edit specification to a media asset in non-real-time. For example, a master asset editor 108 may apply edit specifications to a media asset as part of a scheduled process. In one embodiment, a master asset editor 108 may be used to minimize the necessity of transferring large media assets over a network. For example, by storing edits in an edit specification, a master asset editor 108 may transfer small data files across a network to effectuate manipulations made on a remote computing device to higher quality assets stored on one or more local computers (e.g., computers comprising a master asset library).

In another embodiment, a master asset editor 108 may be responsive to commands from a remote computing device (e.g., clicking a “remix” button at a remote computing device may command the master asset editor 108 to apply an edit specification to a high-resolution media asset). For example, a master asset editor 108 may dynamically and/or interactively apply an edit specification to a media asset upon a user command issuing from a remote computing device. In one embodiment, a master asset editor 108 may dynamically apply an edit specification to a high-resolution to generate an edited high-resolution media asset for playback. In another embodiment, a master asset editor 108 may apply an edit specification to a media asset on a remote computing device and one or more computers connected by a network (e.g., Internet 114). For example, bifurcating the application of an edit specification may minimize the size of the edited high-resolution asset prior to transferring it to a remote computing device for playback. In another embodiment, a master asset editor 108 may apply an edit specification on a remote computing device, for example, to take advantage of vector-based processing that may be executed efficiently on a remote computing device at playtime.

In one embodiment, a system 100 is also comprised of an editor 110 that may reside on a remote computing device 112 that is connected to one or more networked computers, such as the Internet 114. In one embodiment, an editor 110 may be comprised of software. For example, an editor 110 may be a stand-alone program. As another example, an editor 110 may be comprised of one or more instructions that may be executed through another program such as an Internet 114 browser (e.g., Microsoft Internet Explorer). In one embodiment, an editor 110 may be designed with a user interface similar to other media-editing programs. In one embodiment, an editor 110 may contain connections to a master asset library 102, an edit asset library 104, a specification applicator 106 and/or a master asset editor 108. In one embodiment, an editor 110 may include pre-constructed or “default” edit specifications that may be applied by a remote computing device to a media asset. In one embodiment, an editor 110 may include a player program for displaying media assets and/or applying one or more instructions from an edit specification upon playback of a media asset. In another embodiment, an editor 110 may be connected to a player program (e.g., a standalone editor may be connected to a browser).

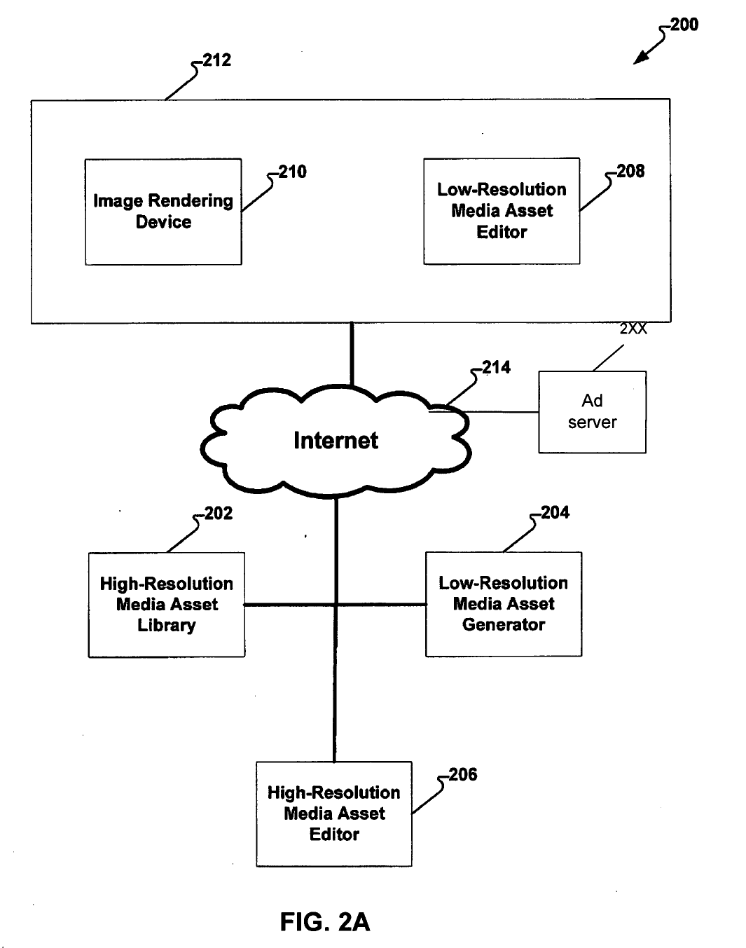

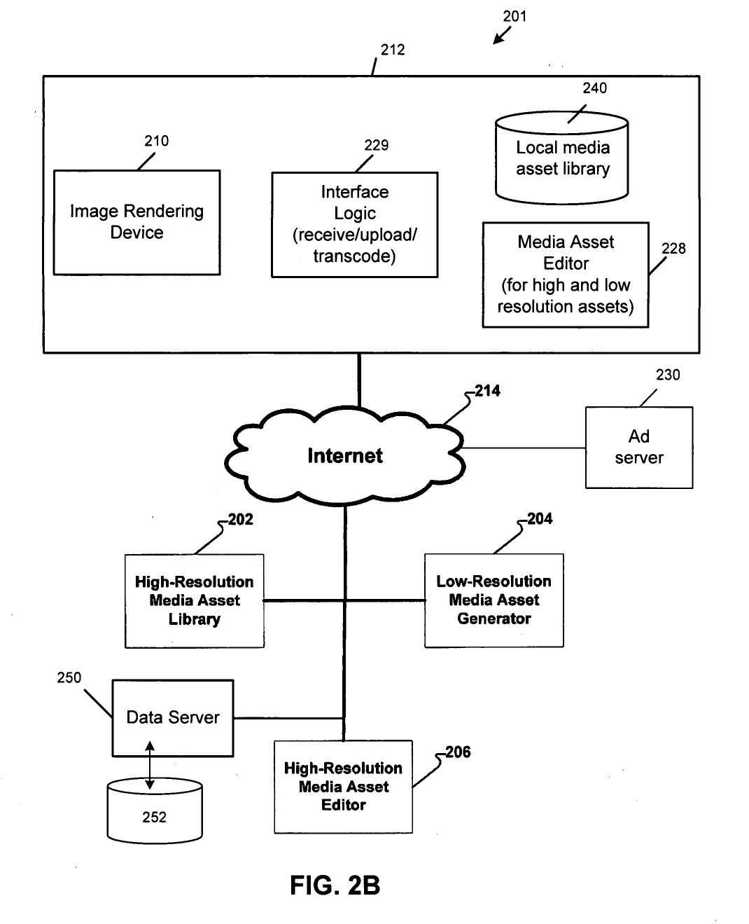

FIG. 2A illustrates an embodiment of a system 200 for generating a media asset. In one embodiment, the system 200 comprises a high-resolution media asset library 202. In one embodiment, the high-resolution media asset library 202 may be a shared library, a public library, and/or a private library. In one embodiment, the high-resolution media asset library 202 may include at least one video file. In another embodiment, the high resolution media asset library 202 may include at least one audio file. In yet another embodiment, the high-resolution media asset library 202 may include at least one reference to a media asset residing on a remote computing device 212. In one embodiment, the high-resolution media asset library 202 may reside on a plurality of computing devices.

In one embodiment, the system 200 further comprises a low-resolution media asset generator 204 that generates low-resolution media assets from high-resolution media assets contained in the high-resolution media asset library. For example, as discussed above, a low-resolution media asset generator 204 may convert a high-resolution media asset to a low-resolution media asset.

In one embodiment, the system 200 further comprises a low-resolution media asset editor 208 that transmits edits made to an associated low-resolution media asset to one or more computers via a network, such as the Internet 214. In another embodiment, the low-resolution media asset editor 208 may reside on a computing device remote from the high resolution media asset editor, for example, remote computing device 212. In another embodiment, the low-resolution media asset editor 208 may utilize a browser. For example, the low-resolution media asset editor 208 may store low-resolution media assets in the cache of a browser.

In one embodiment, the system 200 may also comprise an image rendering device 210 that displays the associated low-resolution media asset. In one embodiment, an image rendering device 210 resides on a computing device 212 remote from the high-resolution media asset editor 206. In another embodiment, an image rendering device 210 may utilize a browser.

In one embodiment, the system 200 further comprises a high-resolution media asset editor 206 that applies edits to a high-resolution media asset based on edits made to an associated low-resolution media asset.

FIG. 2B illustrates another embodiment of a system 201 for generating a media asset. The exemplary system 201 is similar to that of system 200 shown in FIG. 2A, however, in this example, system 201 includes a media asset editor 228 included with computing device 212 operable to retrieve and edit media assets from a remote source, e.g., receive low-resolution media assets corresponding to high-resolution media assets of high-resolution media asset library 202, and also to retrieve and edit media assets originating locally with system 201. For example, a client side editing application including media asset editor 228 may allow for the uploading, transcoding, clipping and editing of multimedia within a client and server architecture that optimizes a user experience by editing files originating from the client on the client and files originating from the server on the server (e.g., by editing a low-resolution version locally as described). Thus, local media assets may be readily accessible for editing without having to first upload them to a remote device.

Further, the exemplary media asset editor 228 may optimize around user wait time by causing the uploading (and/or transcoding) of selected local media assets to a remote device in the background. In one example, only a portion of a local media asset is transmitted (and/or transcoded) to the remote device based on the edits made thereto (e.g., based on an edit instruction), thereby reducing upload time and remote storage requirements. For example, if a user selects to use only a small portion of a large media asset only the small portion is transmitted to the remote device and stored for later use (e.g., for subsequent editing and media asset generation).

Computing device 212 includes a local database 240 for storing media assets which originate locally. For example, media assets stored in local database 240 may include media assets loaded from a device, e.g., a digital camera or removable memory device, or received from a device connected via the Internet 214. Media asset editor 228 is operable to edit the locally stored media assets directly, for example, without waiting to transfer the locally stored media asset to high-resolution media asset library 202 and receiving a low-resolution version for editing.

In one example, interface logic 229 is operable to receive and upload media assets. For example, interface logic 229 is operable to receive and transcode (as necessary) a media asset from high-resolution media asset library 202 or a low-resolution version from low resolution media asset generator 204. Additionally, interface logic 229 is operable to transcode (as necessary) and upload media assets to the high-resolution media asset library 202. In one example, as media asset editor edits a local media asset, e.g., originating or stored with local media asset library database 240, interface logic 229 may upload the local media asset in the background. For example, a user does not need to actively select a local media asset for transfer to the high-resolution media asset library or wait for the transfer (which may take several seconds to several minutes or more) when accessing and editing local media assets. The media assets may be transferred by interface logic 229 as the media assets are selected or opened with the media asset editor 228. In other examples, the local media asset may be transferred when an edit instruction is generated or transferred. Further, in some example, only particular portions of the media asset being edited are transferred, thereby reducing the amount of data to be transferred and the amount of storage used with the remote high-resolution media asset library 202.

Media asset editor 228 causes the generation of an edit instruction associated with the media asset which may be transmitted to a remote server, e.g., including high-resolution media asset editor 206, for example. Additionally, the local media asset may be transmitted to the same or different remote server, e.g., including high-resolution media asset library 240. The local media asset may be transmitted in the background as a user creates edit instructions via media asset editor 228 or may be transmitted at the time of transmitting the edit instruction. Further, low-resolution media asset generator 204 may create a low-resolution media asset associated with the received media asset and transferred to remote device 212 for future editing by media asset editor 228.

High-resolution media asset editor 206 may receive a request to edit a first high-resolution media asset. The low-resolution media asset corresponding to the high-resolution media asset may be generated by low-resolution media asset generator 204 and transferred to computing device 212 as described. Computing device 212 may then generate edit instructions associated with the received low-resolution media asset and a second, locally stored media asset (e.g., originating from local media asset library 240 rather than from high-resolution media asset library 202). Computing device 212 transfers the edit instruction and the second media asset to, for example, high-resolution media asset editor 206 for editing the high-resolution media asset and the second media asset to generate an aggregate media asset.

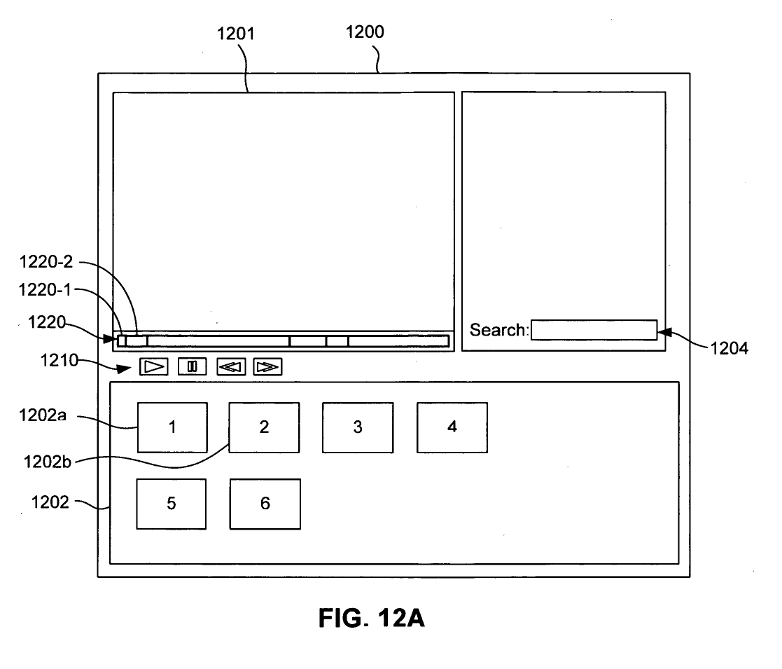

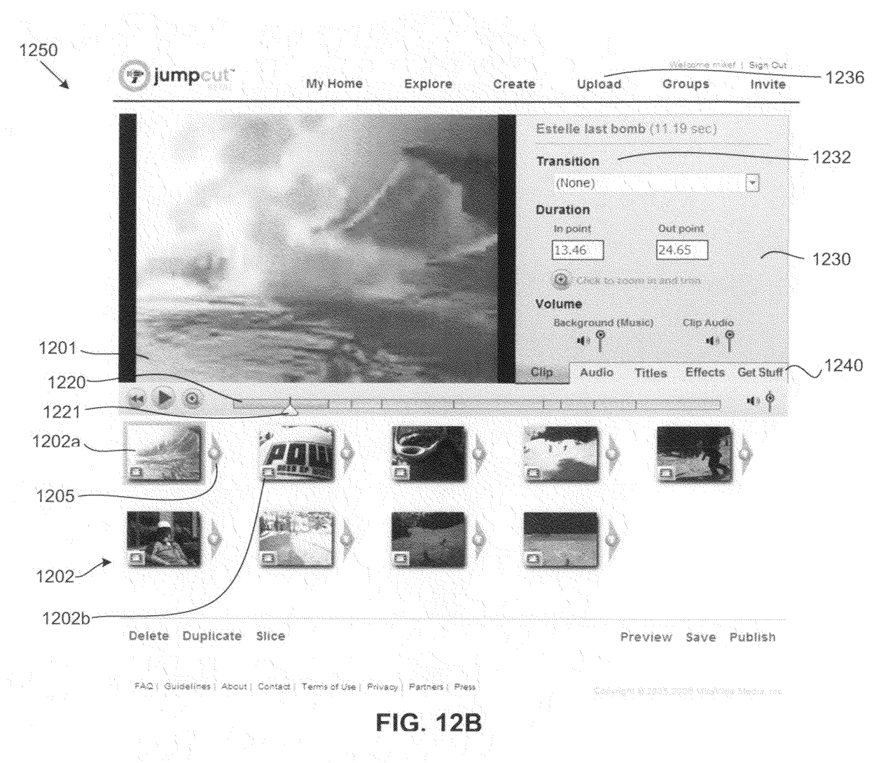

In one example, computing device 212 includes suitable communication logic (e.g., included with or separate from interface logic 229) to interface and communicate with other similar or dissimilar devices, e.g., other remote computing devices, servers, and the like, via network 214 (in part or in whole). For example, communication logic may cause the transmission of a media asset, edit specification, Internet search, and so on. Computing device 212 is further operable to display an interface (see, e.g., interface 1200 or 1250 of FIGS. 12A and 12B) for displaying and editing media assets as described herein, which may be caused in part or in whole by logic executed locally by computing device 212, e.g., via a plug-in or applet downloaded or software installed on computing device 212, or remotely, e.g., by initiating a servlet through a web browser from web server 122. Further, logic, located either locally or remotely, may facilitate a direct or indirect connection between computing device 112 and other remote computing devices (e.g., between two client devices) for sharing media assets, edit specifications, and so on. For example, a direct IP to IP (peer-to-peer) connection may be created between two or more computing devices 212 or an indirect connection may be created through a server via Internet 214.

Computing device 212 includes suitable hardware, firmware, and/or software for carrying out the described functions, such as a processor connected to an input device (e.g., a keyboard), a network interface, a memory, and a display. The memory may include logic or software operable with the device to perform some of the functions described herein. The device may be operable to include a suitable interface for editing media assets as described herein. The device may further be operable to display a web browser for displaying an interface for editing media assets as described.

In one example, a user of computing device 212 may transmit locally stored media assets to a central store (e.g., a high-resolution media asset library 202) accessible by other users or to another user device directly. The user may transfer the media assets as-is or in a low or high-resolution version. A second user may thereafter edit the media assets (whether the media assets directly or a low-resolution version) and generate edit instructions associated therewith. The edit specification may then be communicated to the device 212 and media asset editor 228 may edit or generate a media asset based on the edit specification without the need of also receiving the media assets (as they are locally stored or accessible). In other words, the user provides other users access to local media assets (access may include transmitting low or high-resolution media assets) and receives an edit specification for editing and generating a new media asset from the locally stored media assets.

An illustrative example includes editing various media assets associated with a wedding. For example, the media assets may include one or more wedding videos (e.g., unedited wedding videos from multiple attendees) and pictures (e.g., shot by various attendees or professionals). The media assets may originate from one or more users and be transmitted or accessible to one or more second users. For example, the various media assets may be posted to a central server or sent to other users (as high or low-resolution media assets) such that the other users may edit the media assets, thereby generating edit instructions. Edit instructions/specifications are then communicated to the user (or source of the media assets) for generating an edited or aggregate media asset.

In some examples, high-resolution media assets referenced in an edit specification or instructions for use in an aggregate media asset may be distributed across multiple remote devices or servers. In one example, if a user at a particular remote device wishes to render the aggregate media asset, the desired resolution media assets (e.g., if high and low-resolution media assets are available) are retrieved and rendered at that device, whether at a remote computing device or a remote server. In another example, a determination of where the majority of the desired resolution media assets are located may drive the decision of where to render the aggregate media asset. For example, if ten media assets are needed for rendering and eight of the desired resolution media assets are stored with a first remote device and two media assets are stored with a second remote device, the system may transmit the two media assets with the second remote device to the first device for rendering. For example, the two media assets may be transferred peer-to-peer or via a remote server for rendering at the first device with all ten high-resolution media assets. Other factors may be considered to determine the location for rendering as will be understood by those of ordinary skill in the art; for example, various algorithms for determining processing speeds, transmission speeds/times, bandwidth, locations of media assets, and the like across a distributed system are contemplated. Further, such considerations and algorithms may vary depending on the particular application, time and monetary considerations, and so on.

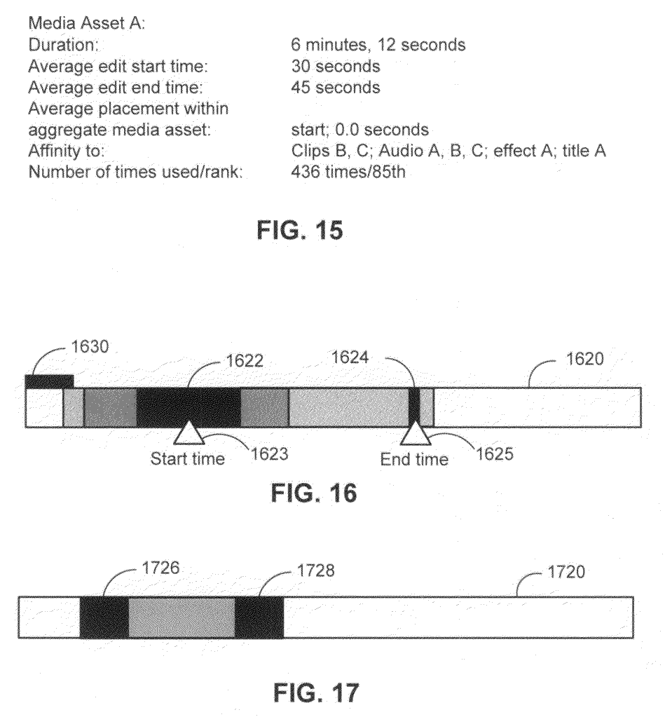

According to another aspect of the exemplary systems, various user activity data is collected as users view, edit, and generate media assets. The activity data may relate to the stored media assets stored with an asset library or generated edit specifications and instructions related to individual media assets and aggregate media assets. The activity data may include various metrics such as frequency of use or views of media assets, edit specifications, ratings, affinity data/analysis, user profile information, and the like. Additionally, activity data associated with a community of users (whether all users or subsets of users), media assets, edit specifications/instructions, and the like may be stored and analyzed to generate various objects. From such data, various objects may be generated or created; for example, new media assets and/or edit instructions/specifications may be generated based on user activity data as discussed with respect to FIGS. 15-17. Additionally, various data associated with media assets may be generated and accessible to users, for example, frequency data, affinity data, edit instruction/specification data, and so on to assist users in editing and generating media assets.

Such user activity data may be stored, e.g., by data storage server 250 and stored in an associated database 252. Data storage server 250 and database 252 may be associated with a common network as the high-resolution media asset library 202 and/or high-resolution media asset editor 206 or remote thereto. In other examples, user activity data may be stored with high-resolution media asset library 202 or high-resolution media asset editor 206.

Additionally, an advertisement server 230 may operate to cause the delivery of an advertisement to remote computing device 212. Advertisement server 230 may also associate advertisements with media assets/edit specifications transmitted to remote computing device. For example, advertisement server 230 may include logic for causing advertisements to be displayed with or associated with delivered media assets or edit specifications based on various factors such as the media assets generated, accessed, viewed, and/or edited, as well as other user activity data associated therewith. In other examples, the advertisements may alternatively or additionally be based on activity data, context, user profile information, etc. associated with computing device 212 or a user thereof (e.g., accessed via remote computing device 212 or an associated web server). In yet other examples, the advertisements may be randomly generated or associated with computer device 212 or media assets and delivered to remote computing devices 212.

It will be recognized that high-resolution media asset library 202, low-resolution media asset generator 204, high resolution media asset editor 206, data server 250 and data base 252, and advertisement server 230 are illustrated as separate items for illustrative purposes only. In some examples, the various features may be included in whole or in part with a common server device, server system or provider network (e.g., a common backend), or the like; conversely, individually shown devices may be comprise multiple devices and be distributed over multiple locations. Further, various additional servers and devices may be included such as web servers, mail servers, mobile servers, and the like as will be understood by those of ordinary skill in the art.

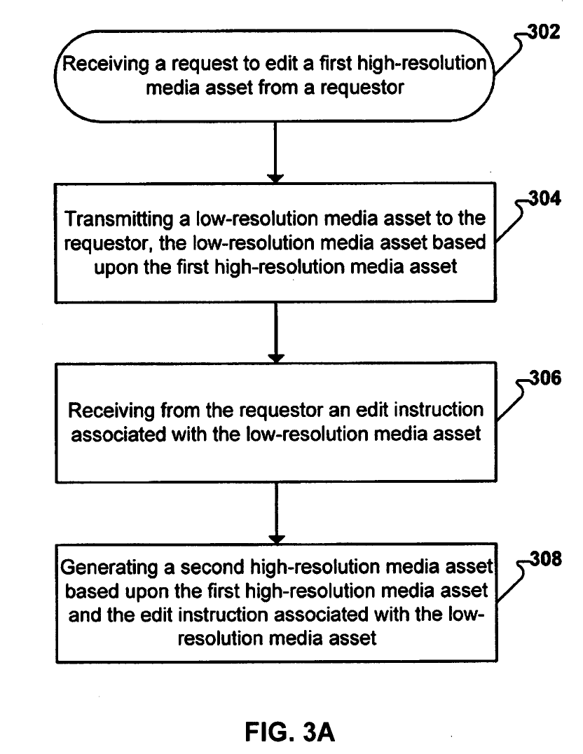

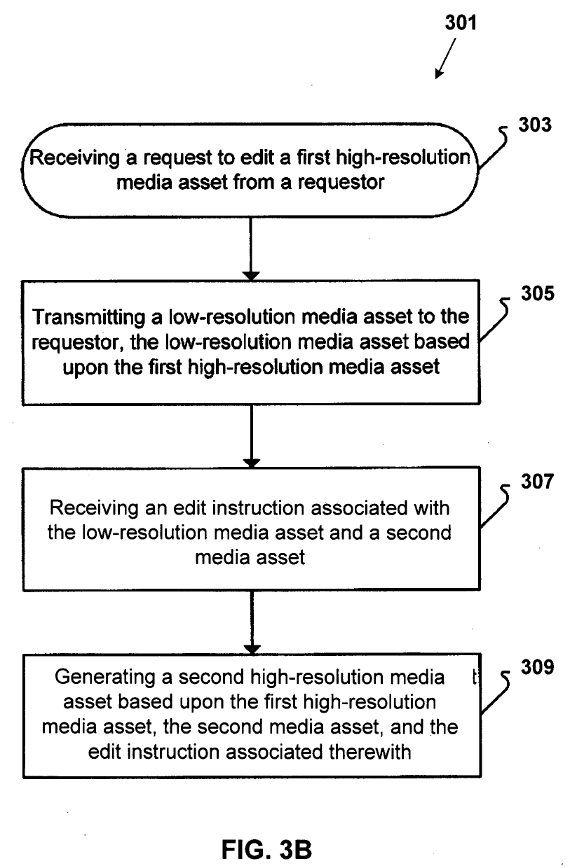

FIG. 3A illustrates an embodiment of a method 300 for editing a low-resolution media asset to generate a high-resolution edited media asset. In the method 300, a request to edit a first high-resolution media is received from a requester in a requesting operation 302. In one embodiment, the first high-resolution media asset may be comprised of a plurality of files and receiving a request to edit the first high-resolution media asset in requesting operation 302 may further comprise receiving a request to edit at least one of the plurality of files. In another embodiment, requesting operation 302 may further comprise receiving a request to edit at least one high-resolution audio or video file.

In the method 300, a low-resolution media asset based upon the first high-resolution media asset is transmitted to a requestor in a transmitting operation 304. In one embodiment, transmitting operation 304 may comprise transmitting at least one low-resolution audio or video file. In another embodiment, transmitting operation 304 may further comprise converting at least one high-resolution audio or video file associated with a first high-resolution media asset from a first file format into at least one low-resolution audio or video file, respectively, having a second file format. For example, a high-resolution uncompressed audio file (e.g., a WAV file) may be converted into a compressed audio file (e.g., an MP3 file). As another example, a compressed file with a lesser compression ratio may be converted into a file of the same format, but formatted with a greater compression ratio.

The method 300 then comprises receiving from a requestor an edit instruction associated with a low-resolution media asset in receiving operation 306. In one embodiment, receiving operation 306 may further comprise receiving an instruction to modify a video presentation property of at least one high-resolution video file. For example, modification of a video presentation property may include receiving an instruction to modify an image aspect ratio, a spatial resolution value, a temporal resolution value, a bit rate value, or a compression value. In another embodiment, receiving operation 306 may further comprise receiving an instruction to modify a timeline (e.g., sequence of frames) of at least one high-resolution video file.

The method 300 further comprises generating a second high-resolution media asset based upon the first high-resolution media asset and the edit instruction associated with the low-resolution media asset in a generating operation 308. In one embodiment of generating operation 308, an edit specification is applied to at least one high-resolution audio or video file comprising the first high-resolution media asset. In a further embodiment, generating operation 308 generates at least one high-resolution audio or video file. In another embodiment, generating operation 308 further comprises the steps of: generating a copy of at least one high-resolution audio or video file associated with a first high-resolution media asset; applying the edit instruction, respectively, to the at least one high-resolution audio or video file; and saving the copy as a second high-resolution media asset.

In another embodiment of method 300, at least a portion of the second high-resolution media asset may be transmitted to a remote computing device. In still yet another embodiment of method 300, at least a portion of the second high-resolution media asset may be displayed by an image rendering device. For example, the image rendering device may take the form of a browser residing at a remote computing device.

FIG. 3B illustrates an embodiment of a method 301 for optimizing editing of local and remote media assets. In this exemplary method, a request to edit a first high-resolution media is received from a requestor in a requesting operation 303 and a low-resolution media asset based upon the first high-resolution media asset is transmitted to a requestor in a transmitting operation 305. This is similar to the method described with respect to FIG. 3A and portions 302 and 304.

The method 301 further comprises receiving from a requester an edit instruction associated with the low-resolution media asset transmitted to the requestor and a second media asset in receiving operation 307, the second media asset originating from the requestor. In one embodiment, the edit instruction and the second media asset are received at the same time; in other examples, they are received in separate transmissions. For example, as a requester selects the second media asset via an editor the second media asset may be transmitted at that time. In other examples, the second media asset is not transferred until the user transmits the edit specification. In yet another example, the second media asset received is only a portion of a larger media asset stored locally with the requestor.

The method 301 further comprises generating an aggregate media asset based upon the first high-resolution media asset, the received second media asset, and the edit instruction associated with the low-resolution media asset and the second media asset in a generating operation 309. In one embodiment of generating operation 309, an edit specification is applied to at least one high-resolution audio or video file comprising the first high-resolution media asset and the second media asset. In a further embodiment, generating operation 309 generates at least one high-resolution audio or video file. In another embodiment, generating operation 308 further comprises the steps of: generating a copy of at least one high-resolution audio or video file associated with a first high-resolution media asset; applying the edit instruction, respectively, to the at least one high-resolution audio or video file; and saving the copy as a second high-resolution media asset.

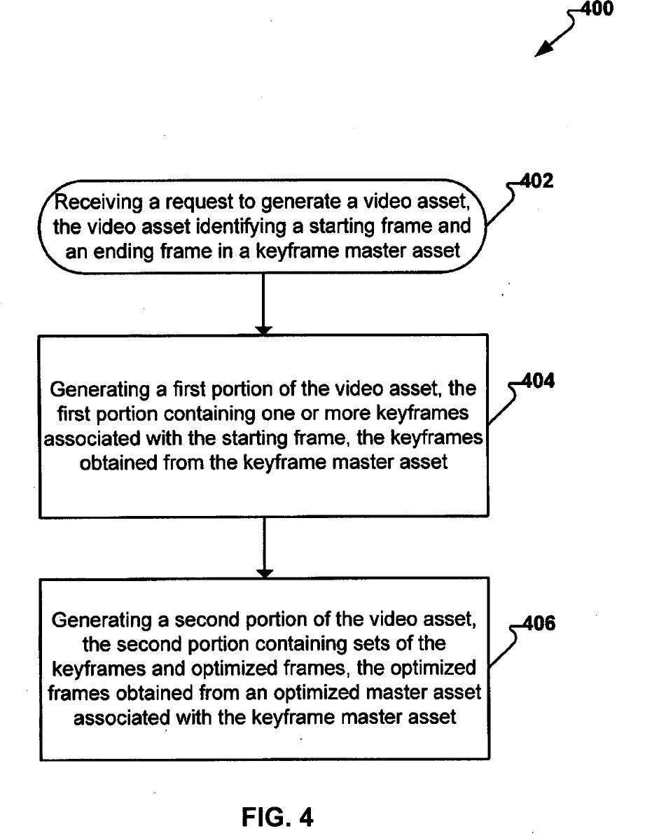

FIG. 4 illustrates an embodiment of a method 400 for generating a media asset. In the method 400, a request to generate a video asset, the video asset identifying a starting frame and an ending frame in a keyframe master asset, is received in receiving operation 402. For example, the request of receiving operation 402 may identify a first portion and/or a second portion of a video asset.

In a generating a first portion operation 404, the method 400 then comprises generating a first portion of the video asset where the first portion contains one or more keyframes associated with the starting frame and the keyframes are obtained from the keyframe master asset. For example, where the keyframe master asset comprises an uncompressed video file, one or more frames of the uncompressed video file may comprise the keyframes associated with the starting frame of the media asset.

In a generating a second portion operation 406, the method 400 further comprises generating a second portion of the video asset where the second portion contains sets of the keyframes and optimized frames and the optimized frames obtained from an optimized master asset associated with the keyframe master asset. For example, where the optimized master asset comprises a compressed video file, a set of frames that are compressed may be combined in a video asset with one or more uncompressed frames from an uncompressed video file.

In another embodiment of method 400, a library of master assets may be maintained such that a keyframe master asset and an optimized master asset may be generated corresponding to at least one of the library master assets. In still yet another embodiment of method 400, a request may identify a starting keyframe or ending keyframe in a keyframe master asset that corresponds, respectively, to a starting frame or ending frame.

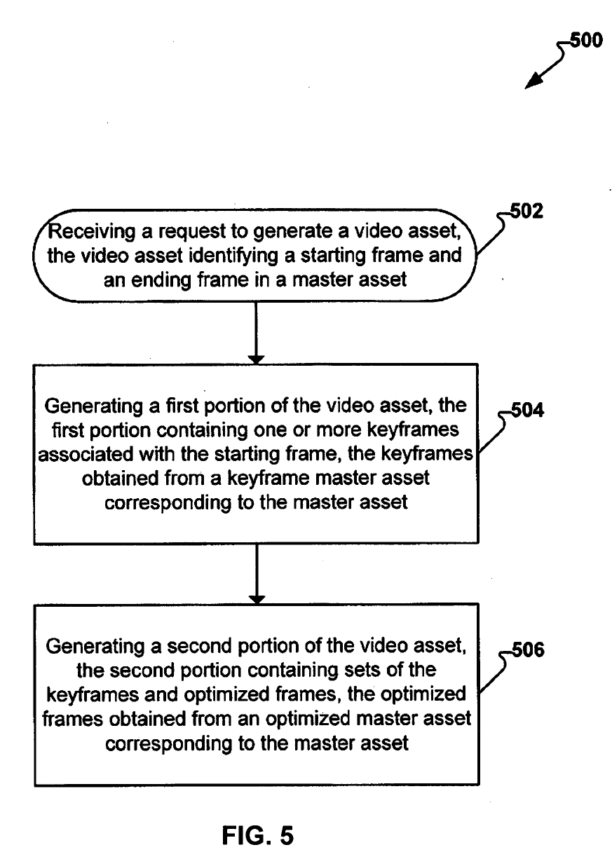

FIG. 5 illustrates an embodiment of a method 500 for generating a media asset. In the method 500, a request to generate a video asset, the video asset identifying a starting frame and an ending frame in a master asset, is received in receiving operation 502. For example, the request of receiving operation 502 may identify a first portion and/or a second portion of a video asset.

In a generating a first portion operation 504, the method 500 then comprises generating a first portion of the video asset where the first portion contains one or more keyframes associated with the starting frame and the keyframes obtained from a keyframe master asset correspond to a master asset.

In a generating a second portion operation 506, the method 500 then comprises generating a second portion of the video asset where the second portion contains sets of the keyframes and optimized frames and the optimized frames obtained from an optimized master asset correspond to a master asset. For example, where the optimized master asset comprises a compressed video file, a set of frames that are compressed may be combined in a video asset with one or more uncompressed keyframes from a keyframe master asset.

In another embodiment of method 500, a library of master assets may be maintained such that a keyframe master asset and an optimized master asset may be generated corresponding to at least one of the library master assets. In still yet another embodiment of method 500, a request may identify a starting keyframe or ending keyframe in a keyframe master asset that corresponds, respectively, to a starting frame or ending frame.

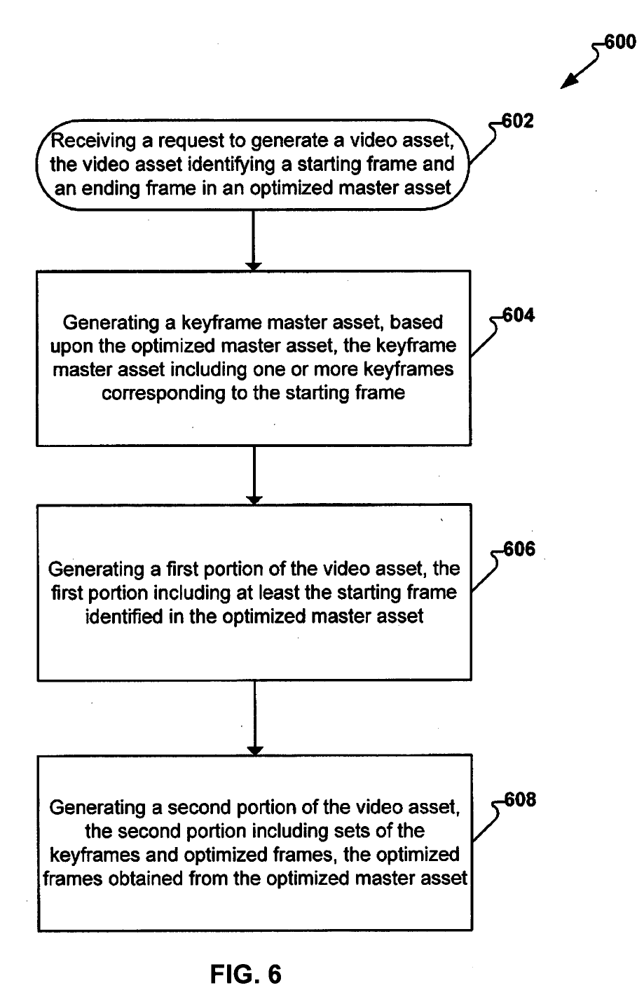

FIG. 6 illustrates an embodiment of a method 600 for generating a media asset. In the method 600, a request to generate a video asset where the video asset identifies a starting frame and an ending frame in an optimized master asset is received in a receiving operation 602. For example, the request of receiving operation 602 may identify a first portion and/or a second portion of a video asset.

The method 600 then comprises generating a keyframe master asset, based upon the optimized master asset, that includes one or more keyframes corresponding to the starting frame in a generating a keyframe operation 604. In a generating a first portion operation 606, the method 600 further comprises generating a first portion of the video asset where the first portion includes at least a starting frame identified in an optimized master asset. In a generating a second portion operation 608, the method 600 then further comprises generating a second portion of the video asset where the second portion includes sets of keyframes and optimized frames and the optimized frames are obtained from the optimized master asset.

In another embodiment of method 600, a library of master assets may be maintained such that a keyframe master asset and an optimized master asset may be generated corresponding to at least one of the library master assets. In still yet another embodiment of method 600, a request may identify a starting keyframe or ending keyframe in a keyframe master asset that corresponds, respectively, to a starting frame or ending frame.

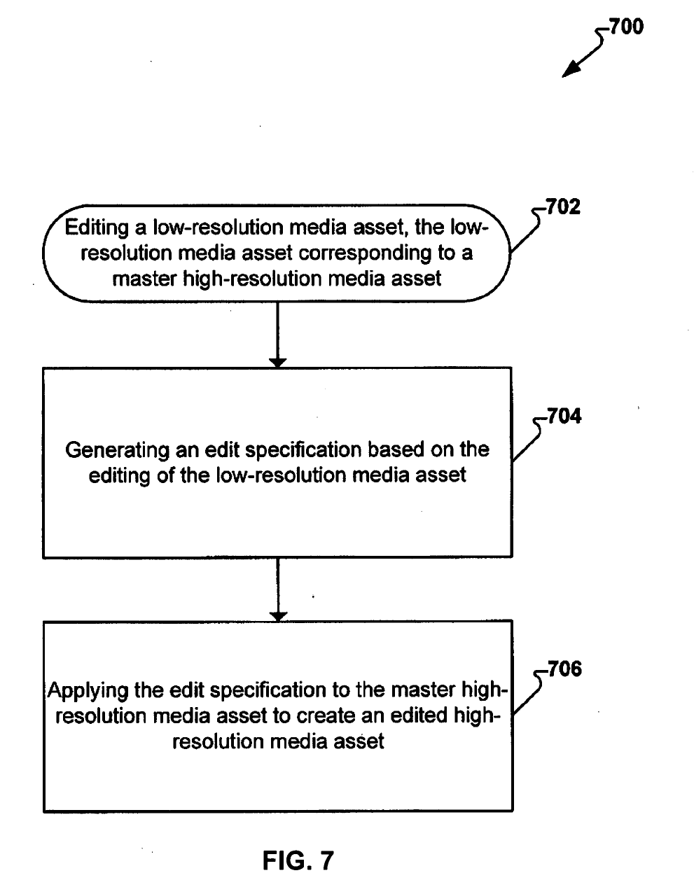

FIG. 7 illustrates an embodiment of a method 700 for recording edits to media content. In the method 700, a low-resolution media asset corresponding to a master high-resolution media asset is edited in editing operation 702. In one embodiment, editing comprises modifying an image of a low-resolution media asset that corresponds to a master high-resolution media asset. For example, where an image includes pixel data, the pixels may be manipulated such that they appear in a different color or with a different brightness. In another embodiment, editing comprises modifying the duration of a low-resolution media asset corresponding to a duration of a master high-resolution media asset. For example, modifying a duration may include shortening (or “trimming”) a low-resolution media asset and the high-resolution media asset corresponding to the low-resolution media asset.

In a further embodiment, where the master high-resolution media asset and the low-resolution media asset comprise at least one or more frames of video information, the editing comprises modifying a transition property of the at least one or more frames of video information of a low-resolution media asset that corresponds to a master high-resolution media asset. For example, a transition such as a fade-in or fade-out transition may replace an image of one frame with an image of another frame. In another embodiment, editing comprises modifying a volume value of an audio component of a low-resolution media asset corresponding to a master high-resolution media asset. For example, a media asset including video information may include an audio track that may be played louder or softer depending upon whether a greater or lesser volume value is selected.

In another embodiment, where the master high-resolution media asset and the low-resolution media asset comprise at least two or more frames of sequential video information, editing comprises modifying the sequence of the at least two or more frames of sequential video information of a low-resolution media asset corresponding to a master high-resolution media asset. For example, a second frame may be sequenced prior to a first frame of a media asset comprising video information.

In still yet another embodiment, editing comprises modifying one or more uniform resource locators (e.g., URLs) associated with a low-resolution media asset corresponding to a master high-resolution media asset. In still another embodiment, editing comprises modifying a playback rate (e.g., 30 frames per second) of the low-resolution media asset corresponding to the master high-resolution media asset. In yet another embodiment, editing comprises modifying the resolution (e.g., the temporal or spatial resolution) of a low-resolution media asset corresponding to a master high-resolution media asset. In one embodiment, editing may occur on a remote computing device. For example, the edit specification itself may be created on a remote computing device. Similarly, for example, the edited high-resolution media asset may be transmitted to the remote computing device for rendering on an image rendering device such as a browser.

The method 700 then comprises generating an edit specification based on the editing of the low-resolution media asset in a generating operation 704. The method 700 further comprises applying the edit specification to the master high-resolution media asset to create an edited high-resolution media asset in an applying operation 706. In one embodiment, the method 700 further comprises rendering an edited high-resolution media asset on an image-rendering device. For example, rendering an edited high-resolution media asset may itself comprise applying a media asset filter to the edited high-resolution media asset. As another example, applying the media asset filter may comprise overlaying the edited high-resolution media asset with an animation. As yet another example, applying the media asset filter may further comprise changing a display property of the edited high-resolution media asset. Changing a display property may include, but is not limited to, changing a video presentation property. In this example, applying the media asset filter may comprise changing a video effect, a title, a frame rate, a trick-play effect (e.g., a media asset filter may change a fast-forward, pause, slow-motion and/or rewind operation), and/or a composite display (e.g., displaying at least a portion of two different media assets at the same time, such as in the case of picture-in-picture and/or green-screen compositions). In another embodiment, the method 700 may further comprise storing an edit specification. For example, an edit specification may be stored at a remote computing device or one or more computers connected via a network, such as via the Internet.

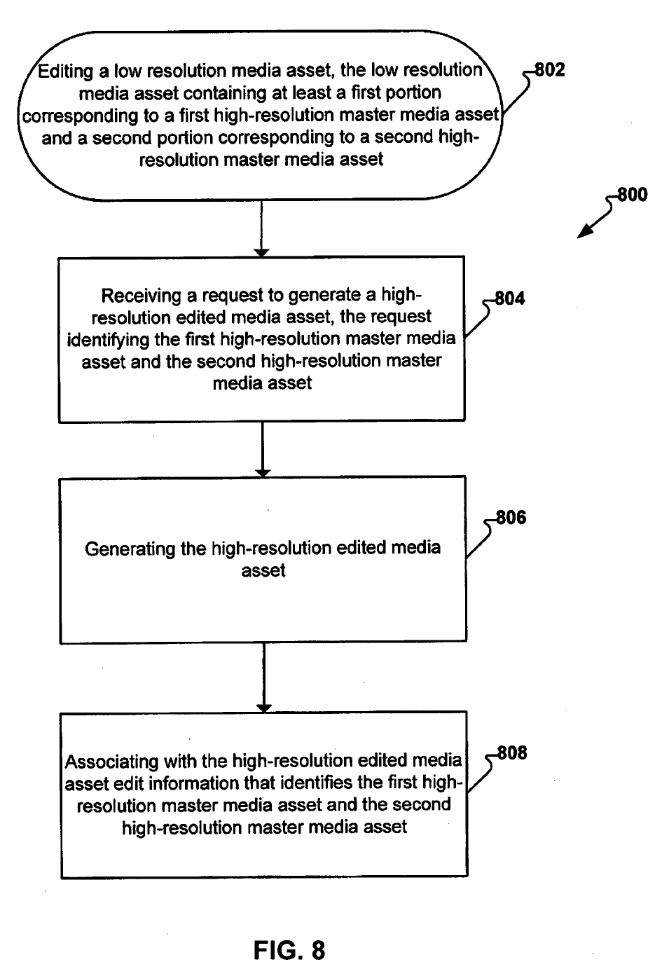

FIG. 8 illustrates an embodiment of a method 800 for identifying edit information of a media asset. In the method 800, a low-resolution media asset is edited in an editing operation 802 where the low-resolution media asset contains at least a first portion corresponding to a first high-resolution master media asset and a second portion corresponding to a second high-resolution master media asset. In one embodiment, editing operation 802 further comprises storing at least some of the edit information as metadata with a high-resolution edited media asset. In another embodiment, editing operation 802 may occur on a remote computing device.

In receiving operation 804, the method 800 then comprises receiving a request to generate a high-resolution edited media asset where the request identifies a first high-resolution master media asset and a second high-resolution master media asset. The method 800 then comprises generating a high-resolution edited media asset in a generating operation 806. The method 800 further comprises associating with a high-resolution edited media asset edit information that identifies the first high-resolution master media asset and the second high-resolution master media asset in an associating operation 808.

In one embodiment, method 800 further comprises retrieving either a first high-resolution master media asset or a second high-resolution master media asset. In yet another embodiment, method 800 still further comprises assembling a retrieved first high-resolution media asset and a retrieved second high-resolution media asset into a high-resolution edited media asset.

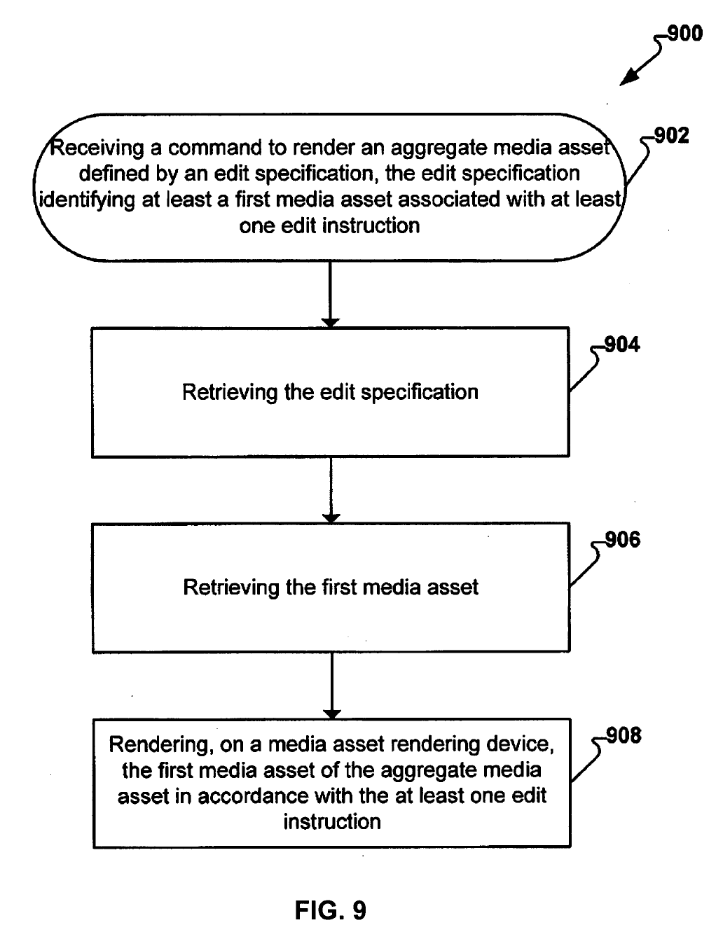

FIG. 9 illustrates an embodiment of a method 900 for rendering a media asset. In the method 900, a command to render an aggregate media asset defined by an edit specification, where the edit specification identifies at least a first media asset associated with at least one edit instruction, is received in receiving operation 902. In one embodiment, receiving operation 902 comprises an end-user command. In another embodiment, receiving operation 902 may comprise a command issued by a computing device, such as a remote computing device. In yet another embodiment, receiving operation 902 may be comprised of a series of commands that together represents a command to render an aggregate media asset defined by an edit specification.

In edit specification retrieving operation 904, an edit specification is retrieved. In an embodiment, retrieving operation 904 may comprise retrieving an edit specification from memory or some other storage device. In another embodiment, retrieving operation 904 may comprise retrieving an edit specification from a remote computing device. In yet another embodiment, retrieving an edit specification in retrieving operation 904 may comprise retrieving several edit specifications that collectively comprise a single related edit specification. For example, several edit specifications may be associated with different media assets (e.g., the acts of a play may each comprise a media asset) that together comprise a single related edit specification (e.g., for an entire play, inclusive of each act of the play). In one embodiment, the edit specification may identify a second media asset associated with a second edit instruction that may be retrieved and rendered on a media asset rendering device.

In media asset retrieving operation 906, a first media asset is retrieved. In one embodiment, retrieving operation 906 may comprise retrieving a first media asset from a remote computing device. In another embodiment, retrieving operation 906 may comprise retrieving a first media asset from memory or some other storage device. In yet another embodiment, retrieving operation 906 may comprise retrieving a certain portion (e.g., the header or first part of a file) of a first media asset. In another embodiment of retrieving operation 906, a first media asset may be comprised of multiple sub-parts. Following the example set forth in retrieving operation 904, a first media asset in the form of a video (e.g., a play with multiple acts) may be comprised of media asset parts (e.g., multiple acts represented as distinct media assets). In this example, the edit specification may contain information that links together or relates the multiple different media assets into a single related media asset.

In rendering operation 908, the first media asset of the aggregate media asset is rendered on a media asset rendering device in accordance with the at least one edit instruction. In one embodiment, the edit instruction may identify or point to a second media asset. In one embodiment, the media asset rendering device may be comprised of a display for video information and speakers for audio information. In an embodiment where there exists a second media asset, the second media asset may include information that is similar to the first media asset (e.g., both the first and second media assets may contain audio or video information) or different from the first media asset (e.g., the second media asset may contain audio information, such as a commentary of a movie, whereas the first media asset may contain video information, such as images and speech, for a movie). In another embodiment, rendering operation 908 may further include an edit instruction that modifies a transition property for transitioning from a first media asset to a second media asset, that overlays effects and/or titles on an asset, that combines two assets (e.g., combinations resulting from edit instructions directed towards picture-in-picture and/or green-screen capabilities), that modifies the frame rate and/or presentation rate of at least a portion of a media asset, that modifies the duration of the first media asset, that modifies a display property of the first media asset, or that modifies an audio property of the first media asset.

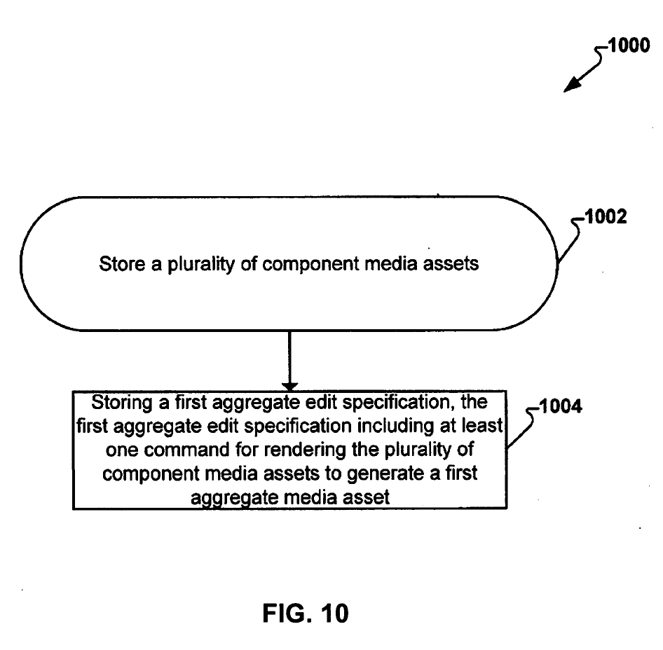

FIG. 10 illustrates an embodiment of a method 1000 for storing an aggregate media asset. In the method 1000, a plurality of component media assets are stored in storing operation 1002. For example, by way of illustration and not of limitation, storing operation 1002 may comprise caching at least one of the plurality of component media assets in memory. As another example, one or more component media assets may be cached in the memory cache reserved for a program such as an Internet browser.

In storing operation 1004, a first aggregate edit specification is stored where the first aggregate edit specification includes at least one command for rendering the plurality of component media assets to generate a first aggregate media asset. For example, an aggregate media asset may comprise one or more component media assets containing video information. In this example, the component videos may be ordered such that they may be rendered in a certain order as an aggregate video (e.g., a video montage). In one embodiment, storing operation 1004 comprises storing at least one command to display, in a sequence, a first portion of the plurality of component media assets. For example, the command to display may modify the playback duration of a component media asset including video information. In another embodiment of storing operation 1004, at least one command to render an effect corresponding to at least one of the plurality of component media assets may be stored. As one example, storing operation 1004 may include one or more effects that command transitions between component media assets. In still yet another embodiment of storing operation 1004, a second aggregate edit specification, the second aggregate edit specification including at least one command for rendering the plurality of component media assets to generate a second aggregate media asset may be stored.

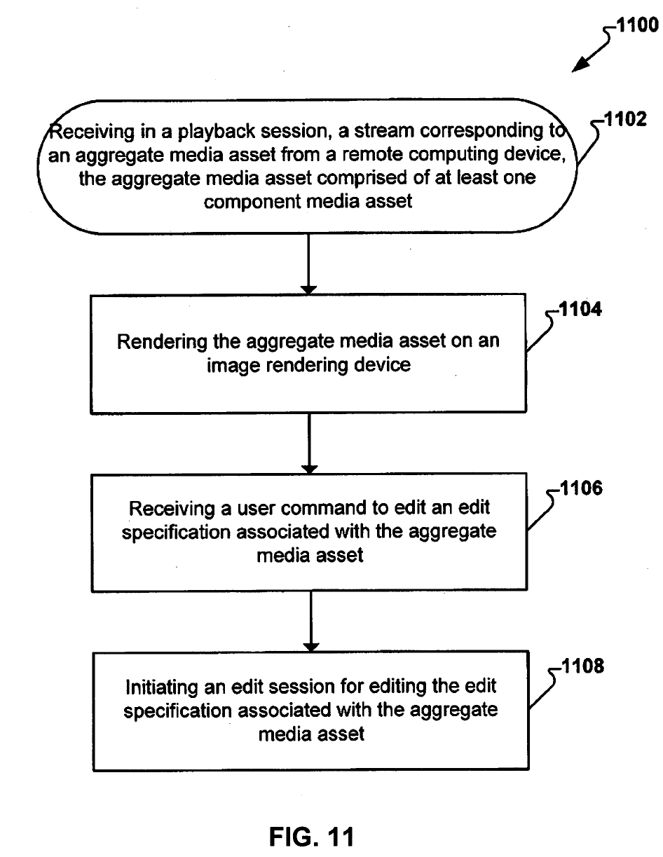

FIG. 11 illustrates an embodiment of a method for editing an aggregate media asset. In the method 1100, a stream corresponding to an aggregate media asset from a remote computing device, the aggregate media asset comprised of at least one component media asset, is received in a playback session in receiving operation 1102. For example, a playback session may be comprised of a user environment that permits playback of a media asset. As another example, a playback session may be comprised of one or more programs that may display one or more files. Following this example, a playback session may be comprised of an Internet browser that is capable of receiving a streaming aggregate media asset. In this example, the aggregate media asset may be comprised of one or more component media assets residing on remote computing devices. The one or more component media assets may be streamed so as to achieve bandwidth and processing efficiency on a local computing device.

In a rendering operation 1104, the aggregate media asset is rendered on an image rendering device. For example, the aggregate media asset may be displayed such that pixel information from an aggregate media asset including video information is shown. In a receiving operation 1106, a user command to edit an edit specification associated with the aggregate media asset is received. As discussed previously, edit specifications may take many forms, including but not limited to one or more files containing metadata and other information associated with the component media assets that may be associated with an aggregate media asset.

In an initiating operation 1108, an edit session is initiated for editing the edit specification associated with the aggregate media asset. In one embodiment, initiating operation 1108 comprises displaying information corresponding to the edit specification associated with the aggregate media asset. For example, an editing session may permit a user to adjust the duration of a certain component media asset. In another embodiment, method 1100 further comprises modifying the edit specification associated with the aggregate media asset, thereby altering the aggregate media asset. Following the previous example, once a component media asset is edited in the editing session, the edits to the component media asset may be made to the aggregate media asset.

FIG. 12A illustrates an embodiment of a user interface 1200 for editing media assets, and which may be used, e.g., with computing device 212 illustrated in FIGS. 2A and 2B. Generally, interface 1200 includes a display 1201 for displaying media assets (e.g., displaying still images, video clips, and audio files) according to controls 1210. Interface 1200 further displays a plurality of tiles, e.g., 1202a, 1202b, etc., where each tile is associated with a media asset selected for viewing and/or editing, and which may be displayed individually or as an aggregate media asset in display 1201.

In one example, interface 1200 includes a timeline 1220 operable to display relative times of a plurality of media assets edited into an aggregate media asset; and in one example, timeline 1220 is operable to concatenate automatically in response to user edits (e.g., in response to the addition, deletion, or edit of a selected media asset). In another example, which may include or omit timeline 1220, interface 1200 includes a search interface 1204 for searching for media assets; for example, interface 1200 may be used for editing media assets in an on-line client-server architecture as described, wherein a user may search for media assets via search interface 1204 and select new media assets for editing within interface 1200.

Display portion 1202 displays a plurality of tiles 1202a, 1202b, each tile associated with a media asset, e.g., a video clip. The media asset may be displayed alone, e.g., in display 1201 in response to a selection of the particular tile, or as part of an aggregate media asset based on the tiles in display portion 1202. Individual tiles 1202a, 1202b, etc., may be deleted or moved in response to user input. For example, a user may drag-and-drop tiles to reorder them, the order dictating the order in which they are aggregated for an aggregate media asset. A user may further add tiles by selecting new media assets to edit, e.g., by opening files via conventional drop-down menus, or selecting them via search interface 1204, discussed in greater detail below. Additionally, each tile can be associated with a media asset or a portion of a media asset; for example, a user may “slice” a media asset to create two tiles, each corresponding to segments of the timeline, but based on the same media asset. Additionally, tiles may be duplicated within display portion 1202.

In one example, each tile displays a portion of the media asset, e.g., if the tile is associated with a video clip, the tile may display a still image of the video clip. Additionally, a tile associated with a still image may illustrate a smaller version of the image, e.g., a thumbnail, or a cropped version of the still image. In other examples, a tile may include a title or text associated with the clip, e.g., for an audio file as well as a video file.

In one example, interface 1200 further includes a search interface 1204 allowing a user to search for additional media assets. Search interface 1204 may operate to search remote media assets, e.g., associated with remote storage libraries, sources accessible via the Internet, or the like, etc., as well as locally stored media assets. A user may thereby select or “grab” media assets from the search interface for editing and/or to add them to an associated local or remote storage associated with the user. Additionally, as media assets are selected a new tile may be displayed in the tile portion 1202 for editing.

In one example, search interface 1204 is operable to search only those media assets of an associated service provider library such as media asset library 102 or high resolution media asset library 206 as shown in FIGS. 1, 2A, and 2B. In other examples, search interface 1204 is operable to search media assets for which the user or service provider has a right or license thereto for use (including, e.g., public domain media assets). In yet other examples, the search interface 1204 is operable to search all media assets and may indicate that specific media assets are subject to restrictions on their use (e.g., only a low-resolution version is available, fees may be applicable to access or edit the high-resolution media asset, and so on).

User interface 1200 further includes a timeline 1220 for displaying relative times of each of the plurality of media assets as edited by a user for an aggregate media asset. Timeline 1220 is segmented into sections 1220-1, 1220-2, etc., to illustrate the relative times of each media asset as edited associated with tiles 1202a, 1202b for an aggregate media asset. Timeline 1220 automatically adjusts in response to edits to the media assets, and in one example, timeline 1220 concatenates in response to an edit or change in the media assets selected for the aggregate media asset. For example, if tile 1202b were deleted, the second section 1220-2 of timeline 1220 would be deleted with the remaining sections on either side thereof concatenating, e.g., snapping to remove gaps in the timeline and illustrate the relative times associated with the remaining media assets. Additionally, if tile 1202a and 1202b were switched, e.g., in response to a drag-and-drop operation, sections 1220-1 and 1220-2 would switch accordingly.

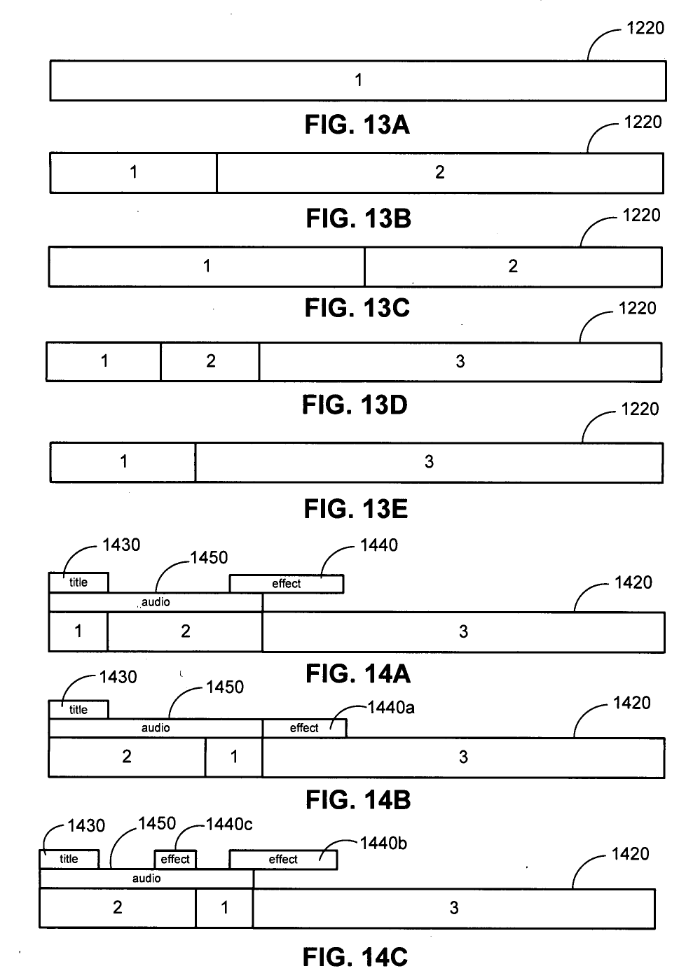

FIGS. 13A-13E illustrate timeline 1220 adjusting in response to edits to the media assets, for example, via the displayed tiles or display of media assets. In particular, in FIG. 13A a single media asset 1 has been selected and spans the entire length of timeline 1220. As a second media asset 2 is added sequentially after media asset 1, as shown in FIG. 13B, the relative times of media assets 1 and 2 are indicated (in this instance media asset 2 is longer in duration than media asset 1 as indicated by the relative lengths or sizes of the segments). In response to a user editing media asset 2 to only include a portion thereof, e.g., by trimming media asset 2, timeline 1220 adjusts to indicate the relative times as edited as shown in FIG. 13C.

FIG. 13D illustrate timeline 1220 after an additional media asset 3 is added, having a time relatively greater than media assets 1 and 2 as indicated by the relative segment lengths, and added sequentially after media asset 3 (note that the relative times of media assets 1 and 2, approximately equal, has been retained by timeline 1220). In response to a user deleting media asset 2, timeline 1220 again automatically adjusts such that media assets 1 and 3 are displayed according to their relative times. Further, the timeline concatenates such that media asset 1 and media asset 3 snap together without a time gap therebetween; for example, media assets 1 and 3 would be displayed, e.g., via display portion 1201 of interface 1200, sequentially without a gap therebetween.

FIG. 12B illustrates a screen shot of an exemplary user interface 1250, which is similar to interface 1200 of FIG. 12A. In particular, similarly to user interface 1200, user interface 1250 includes a tile display 1202 for displaying tiles 1202a, 1202b, etc. each associated with a media asset for editing via user interface 1200, a display portion 1201 for displaying media assets, and a timeline 1220. Timeline 1220 further includes a marker 1221 indicating which portion of the individual media assets and aggregate media asset is being displayed in display portion 1202.

Further, as a tile is selected, e.g., tile 1202a, the tile is highlighted in display 1202 (or otherwise displayed differently than the remaining tiles) to indicate the associated media asset being displayed in display portion 1201. Additionally, the portion of timeline 1220 may be highlighted as shown to indicate the portion of the media asset of the selected tile being displayed, and the relative placement of the media asset within the aggregate media asset.

User interface 1250 further includes a trim feature 1205 for displaying the media asset associated with one of the tiles in the display portion 1201 along with a timeline associated with the selected media asset. For example, trim feature 1205 may be selected and deselected to change display 1201 from a display of an aggregate media asset associated with tiles 1202a, 1202b to a display of an individual media asset associated with a particular tile. When selected to display a media asset associated with a tile, a timeline may be displayed allowing a user to trim the media asset, e.g., select start and end edit times (the timelines may be displayed in addition to or instead of timeline 1220). The selected start and end edit times generating edit instructions, which may be stored or transmitted to a remote editor.

In one example, a timeline is displayed when editing an individual media asset within user interface 1250, the length of the timeline corresponding to the duration of the unedited media asset. Edit points, e.g., start and end edit points may be added along the timeline by a user for trimming the media asset. For example, a start and end time of the media asset may be shown by markers (see, e.g., FIG. 16) along the timeline, the markers initially at the beginning and end of the timeline and movable by a user to adjust or “trim,” the media asset for inclusion in the aggregate media asset. For example, a particular tile may correspond to a two-hour movie, and a user may adjust the start and end times via the timeline to trim the movie down to a five-second portion for inclusion with an aggregate media asset.

User interface 1250 further includes a control portion 1230 for controlling various features of a media asset displayed in display portion 1201, the media asset including an aggregate media asset or individual media asset associated with a tile. In addition or instead of the above described markers along a timeline for trimming a media asset, a user may enter start and end times for a media asset via control portion 1230. Further, a user may adjust the volume of the media asset being displayed and/or an audio file associated therewith. Control portion 1230 further includes a transition selection 1232, which may be used to select transitions (e.g., dissolve, fade, etc.) between selected media assets, e.g., between media assets associated with tiles 1202a and 1202b.

User interface 1250 further includes an “Upload” tab 1236, which switches to or launches an interface for uploading media objects to a remote storage. For example, to upload locally stored media assets to a remote media asset library as described with respect to FIGS. 1, 2A, and 2B.

User interface 1250 further includes tabs 1240 for viewing and selecting from various media assets. For example, a user may select from “Clip,” “Audio,” “Titles,” “Effects,” and “Get Stuff.” In this instance, where “Clip” is selected, the media assets displayed in tile display portion 1202 generally correspond to video or still images (with or without audio). Selection of “Audio” may result in the display of tiles (e.g., with small icons, text, or images) corresponding to various audio files; in other examples, audio may be selected and added to the aggregate media asset without the display of tiles. Additionally, selection of “Titles,” and/or “Effects,” may cause the display or listing of titles (e.g., user entered titles, stock titles, and the like) and effects (e.g., tints, shading, overlaid images, and the like) for selection to include with the aggregate media asset.

Finally, selection of “Get Stuff,” may launch a search interface similar to that of search interface 1204 illustrated and described for user interface 1200 of FIG. 12A. Additionally, an interface may be launched or included in a browser to allow a user to select media assets as they browse the internet, e.g., browsing through a website or other user's media assets. For example, a bin or interface may persist during on-line browsing allowing a user to easily select media assets they locate and store them for immediate or later use (e.g., without necessarily launching or having the editor application running).

In this example, timeline 1220 indicates the relative times of the selected media assets shown in display portion 1202, which are primarily video and still images. In response to selection of other media assets, such as audio, titles, effects, etc., a second timeline associated with portion of time 1220 may be displayed. For example, with reference to FIGS. 14A-14C, embodiments of a timeline displaying associated audio files, titles, and effects are described.

With reference to FIG. 14A, a timeline 1420 is displayed indicating relative times of media assets 1, 2, and 3. In this example, media assets 1, 2, and 3 of timeline 1420 each include videos or images (edited to display for a period of time). Additionally, a title 1430 is displayed adjacent media asset 1, e.g., in this instance title 1430 is set to display for the duration of media asset 1. Further, an audio file 1450 is set to play for the duration of media assets 1 and 2. Finally, an effect 1440 is set for display near the end of media asset 2 and the beginning of media asset 3.

Audio files, titles, and effects may have various rules or algorithms (e.g., set by a service provider or a user) to dictate how the items are associated and “move” in response to edits to the underlying media assets. For example, a title might be associated with the first media asset (i.e., associated with t=0) or the last media asset of an aggregate media asset and remain at that position despite edits to the component media assets. In other examples, a title might be associated with a particular media asset and move or remain in synchronization with the media asset in response to edits thereto.

In other examples, audio files, titles, and effects may span across or be initially synchronized with multiple media assets. For example, with respect to FIG. 14A, audio 1450 spans media assets 1 and 2 and effect 1440 spans media assets 2 and 3. Various algorithms or user selections may dictate how audio files, titles, and effect move in response to edits to the underlying media assets when spanning two or more media assets. For example, effect 1440 may be set, by default or by user selection, to stay in sync with one of the media assets in response to an edit, e.g., based on the majority of the overlap of the effect as shown in FIG. 14B (and in response to an edit switching the order of media assets 1 and 2). In other examples, effect 1440 may divide and continue to be in sync with the same portions of media assets 2 and 3 as originally set as indicated by effect 1440c in FIG. 14C, remain for the original duration and at the same relative location as indicated by effect 1440b in FIG. 14C, or combinations thereof.

According to another aspect of the present invention, media assets may be generated based on aggregate data from a plurality of users. For example, as described previously with respect to FIG. 2B, activity data related to a plurality of users may be tracked, stored, and analyzed to provide information, edit instructions, and media assets. Activity data associated with edit instructions, for example, received by one or more media asset editors such as media asset editor 206, may be stored by data server 250 (or other system). The activity data may be associated with media assets; for example, a plurality of edit instructions referencing a particular media asset may be stored or retrieved from the activity data. Such data may include aggregate trim data, e.g., edited start times and end times of media assets (e.g., of videos and audio files). Certain clips may be edited in similar fashions over time by different users; accordingly, data server 250 (or other remote source) could supply the edit instructions to a remote device to aid in editing decisions.

FIG. 15 illustrates an embodiment of user activity data collected and/or generated from aggregate user activity data. The user activity data generated or derived from user activity may be displayed on a user device or used by an apparatus, e.g., a client or server device, for editing or generating objects, such as media assets. In particular, the duration of a media asset (e.g., a video clip or music file), average edited start time, average edited end time, average placement within an aggregate media asset, an affinity to other media assets, tags, user profile information, frequency of views/rank of a media asset, and the like may be collected or determined. Various other data relating to the media assets and users may be tracked such as counts of user supplied awards (e.g. symbolic items to state the user likes a media asset), as well as any other measurable user interaction. For example, user actions such as pausing then playing, seeking activity, mouse movement of usage of a page or keyboard indicating a user has some interest beyond passively watching, and the like.

In one example, activity data may be used to determine various affinity relationships. The affinity may include an affinity to other media assets, effects, titles, users, and so on. In one example, the affinity data may be used to determine that two or more media assets have an affinity for being used together in an aggregate media asset. Further, the data may be used to determine the proximity that two or more media assets have if used in the same aggregate media asset. For example, a system may provide a user with information in response to selecting clip A (or requesting affinity information) that clip B is the most commonly used clip in combination with clip A (or provide a list of clips that are commonly used with clip A). Additionally, a system may indicate proximity of clips A and B when used in the same aggregate media asset; for example, clips A and B are commonly disposed adjacent each other (with one or the other leading) or within a time X of each other.

In one particular example, the activity data is used to determine an affinity between a song and at least one video clip (or between a video clip and at least one song). For example, particular songs may be commonly used with particular video clips, which may be derived from the activity data. In one example, if a user selects a particular song, the system may provide one or more media assets in the form of video clips, audio files, titles, effects, etc., having an affinity thereto, thereby providing a user with media assets to start editing with.

The activity data may further be used to determine similarities and/or differences between edits instructions to one or more media assets. For example, the system may examine different edits to a media asset or set of media assets and provide data as to commonalities (and/or differences) across different users or groups of users.

Such data may further be used by a server or client apparatus to generate objects, such a timeline associated with a media asset or data sets. FIG. 16 illustrates an embodiment of a timeline 1620 generated from aggregate user activity data, and in particular, from edit instructions from a plurality of users as applied to a media asset. Timeline 1620 generally includes a “start time” and “end time” associated with aggregated edit data of a plurality of users, indicating the portion of the media asset most often used. Further, timeline 1620 may be colored or shaded for displaying a “heat map,” to indicate relative distributions around the start and end edit times. For instance, in this example, a fairly broad distribution is shown around the start edit time 1622, e.g., indicating that users started at various locations centered around a mean or median start edit time 1622 and a relatively sharp mean or median end edit time 1624, indicating that users ended at a relatively common or uniform time.

The aggregate data may be transmitted to a remote computing device for use when displaying a timeline associated with a particular media asset being edited locally. Accordingly, the shading or other indication of aggregate data may be displayed on the timeline. A user may edit the media asset, e.g., move the start edit marker 1623 and end edit marker 1625, while having the aggregate data displayed for reference.

In another example, other media assets such as an audio file or picture, title, effect, or the like may be associated with a particular media asset as indicated by 1630. For example, a particular audio file or effect may have an affinity to a particular media asset and be indicated with the display of timeline 1620. The affinity may be based on the activity data as previously described. In other examples, a list or drop down menu may be displayed with a listing of media assets having an affinity to the media asset associated with timeline 1620.

Objects generated from activity data, such as timeline 1620, may be generated by apparatus remote to a client computing device and transmitted thereto. In other examples, activity data, such as average start and edit times, as well as data to generate a heat map thereof, may be transmitted to a client device, where a client application, e.g., an editor application, generates the object for display to a user.

FIG. 17 illustrates another embodiment of a timeline 1720 generated based on aggregate user data. In this example, timeline 1720 displays the relative position of a media asset as typically used within aggregate media assets. For example, in this instance, timeline 1720 indicates that the associated media asset is generally used near the beginning of an aggregate media asset as indicated by the relative start and end times 1726 and 1728. This may be used, e.g., to indicate that a particular media asset is often used as an intro or ending to an aggregate media asset.

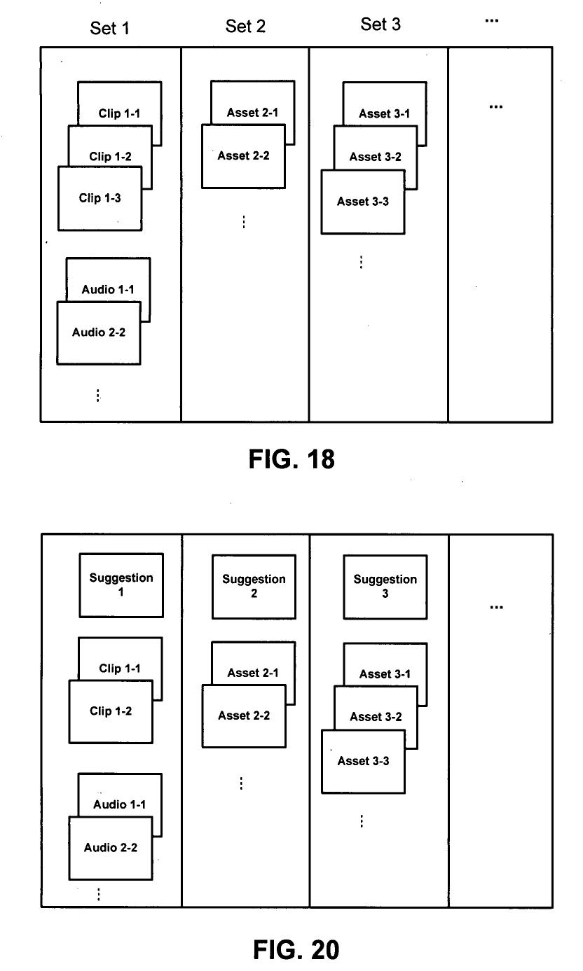

FIG. 18 conceptually illustrates an example of presenting users with media assets and generating media assets based on user activity data. In particular, users are provided access to various sets of media assets, each set corresponding to a scene or segment of an aggregate media asset. In one specific example, each set of media assets comprises at least one video clip, and may further comprise one or more of audio files, pictures, titles, effects, and so on. A user may make selections and edits to the media assets from each set to form an aggregate media asset, e.g., a movie.

In one example, different users edit the scenes by selecting at least one of the media assets in each of the plurality of sets to generate different aggregate media assets. The aggregate media assets and/or edit instructions associated therewith may then be transmitted to a remote or central storage (e.g., data server 250 or the like) and used to create media assets based thereon. In some examples, users may be restricted to only those media assets in each set, in other examples, additional media assets may be used. In either instance, each user may generate a different aggregate media asset based on selections of the media assets.

In one example, the data from selections by different users, e.g., the edit instructions, are used to determine an aggregate media asset. For example, an aggregate media asset may be generated based on the most popular scenes (e.g., selected media assets for each sets) generated by the users. In one example, the aggregate media asset may be generated based on the most popular media assets selected from each set, for example, combining the most common used clip from set 1 with the most common used audio file from set 1, and so on. The most popular scenes may then be edited together for display as a single media asset.

The most popular set may alternatively be based on other user activity data associated with the plurality of user generated aggregate media assets; for example, based on activity data such as frequency of views/downloads, rankings, or the like to determine the most popular sets. The most popular set for each set may then be associated together to form the generated media asset.

In other examples, the most popular media asset of each set (however determined) may be filtered based on the particular users or groups viewing and ranking the movies. For example, children and adults may select or rank media assets of different scenes in different manners. Apparatus may therefore determine an aggregate movie based on most popular scenes according to various subsets of users, e.g., based on age, communities, social groups, geographical locations, languages, other user profile information, and the like.

Apparatus associated with a server system remote to a computing device, e.g., a data server 250, remote editor, or media asset library, may include or access logic for performing the described functions. In particular, logic for receiving user activity data and, depending on the application, logic for determining associations or affinities based on the received activity data. Further, the server system may include logic for editing or generating objects such as media assets, edit instructions, timelines, or data (e.g., affinity data) for transmission to one or more user devices.

According to another aspect and example of the present invention, apparatus for providing suggestions to a user for generating an aggregate media asset within the described architecture is provided. In one example, the apparatus causes the display of suggestions according to a template or storyboard to guide a user in generating a media asset, the suggestions based on context associated with the user. For example, if the user is generating a dating video the apparatus provides suggestions such as “begin with a picture of yourself,” as well as questions such as “are you romantic,” followed by suggestions based on the answers. The suggestions, which may follow a template or storyboard, guide and assist a user through the generation of a media asset. The apparatus may store a plurality of templates or storyboards for various topics and user contexts. Additionally, the apparatus may provide low or high-resolution media assets (e.g., context appropriate video clips, music files, effects, and so on) to assist the user in generating the media asset.

The context may be determined from user input or activity (e.g., in response to inquiries, selection of associated websites where an editor is launched from, such as from a dating website), user profile information such as sex, age, community or group associations, and so on. Additionally, in one example, a user interface or editor application may include selections for “make a music video,” “make a dating video,” “make a real estate video,” “make a wedding video,” and so on.

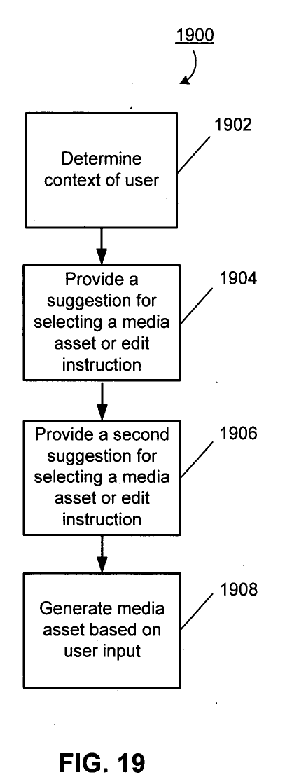

FIG. 19 illustrates an exemplary method 1900 for generating a media asset based on context of a user. Initially, the context of the user is determined at 1902. The context may be derived directly based on the user launching an application or selecting a feature for editing a context specific media asset. For example, the context may be determined from the user selecting “Make a dating video,” or launching an editor application from a dating website.

The method 1900 further includes causing a suggestion to be displayed at 1904. The suggestion may include a suggestion for selecting a media asset or edit instruction. The suggestion may include a question followed by a suggestion for selection of a media asset. For example, continuing with the dating video example, asking the user “Are you athletic,” or “Are you a romantic,” and then suggesting the use of a media asset based on a user response such as suggesting a video clip of the user being athletic (e.g., a video clip of the user playing Frisbee) or showing the user is romantic (e.g., a video clip of a beach or sunset). As a user provides media assets in response to the suggestions, the media asset and/or edit instructions associated therewith may be transmitted to a remote media asset library and/or editor as previously described.

The method 1900 further includes causing a second suggestion to be displayed at 1906, where the suggestion may depend, at least in part, on the selection in response to the previous suggestions. The displayed suggestions may therefore branch depending on answers, selected media assets, edits instructions, or combinations thereof. Any number of iterations of suggestions may be provided to the user, after which a media asset may be generated at 1908 based on edits and selections of media assets by the user. The selection of media assets and/or edit instructions may be transmitted to a remote editor and library (e.g., see FIGS. 2A and 2B). Additionally, in examples where a user receives and edits low-resolution media assets, high-resolution media assets may be transmitted to the user device in response to completion of the media asset for generation of a high-resolution media asset.

In one example, apparatus may further transmit or provide access to media assets in addition to providing suggestions, e.g., auto-provisioning the remote computing device with potential media assets based on the context and/or responses to suggestions. For example, low-resolution media assets associated with high-resolution media assets stored remotely, such as video clips, audio files, effects, etc., may be transmitted to the client device.

FIG. 20 illustrates conceptually an exemplary template 2000 for generating a media asset based on the user context. Template 2000 generally includes a number of suggestions for display to a user for which a user may generate sets of media assets for generating an aggregate media asset. In one example, template 2000 is provisioned with media assets based on the particular template and/or context of the user. For example, template 2000 relates to making a dating video, where media assets are associated therewith (e.g., and are auto-provisioned to a user device) based on the template and user profile information (e.g., based on male/female, age, geographical location, etc.). Accordingly, the template provides a storyboard that a user can populate with media assets to generate a desired video asset.

Apparatus may access or transmit the template to a remote device to cause the display of a first suggestion to a user and a first set of media assets associated therewith. The media assets may auto-populate a user device at the time of displaying the user suggestion or may auto-populate the user devices based on a response to the suggestion (which may include a question). The apparatus may display the sets of suggestions and media assets in a sequential order. In other examples, the sets of suggestions and media assets may branch depending on user actions; for example depending on user responses to suggestions and/or selections of media assets.

Another illustrative example includes making a video for a real estate listing. Initially a user might be presented with and choose from a set of templates, e.g., related to the type of housing and configuration that matches the house to be featured. For example, various templates may be generated based on the type of house (such as detached, attached, condo, etc.) architecture type (such as ranch, colonial, condo, etc.), configuration (such as number of bedrooms and bathrooms), and so on. Each template may provide varying suggestions for creating a video, e.g., for a ranch house beginning with a suggestion for a picture of the front of the house, whereas for a condo the suggestion might be to begin with a view from the balcony or of a common area.

Additionally, in examples where a user is provisioned with media assets, the media assets may vary depending on the template and context. For example, based on an address of the real estate listing different media assets associated with the particular city or location could be provisioned. Additionally, audio files, effects, titles, for example, may vary depending on the particular template.

For the sake of convenience, at times, videos are used and described as examples of media assets manipulated and subject to edit instructions/specifications by the exemplary devices, interfaces, and methods; however, those skilled in the art will recognize that the various examples apply similarly or equally to other media objects, subject to appropriate modifications and use of other functions where appropriate (e.g., viewing and editing a media asset may apply to editing a video file (with or without audio), editing an audio file, such as a soundtrack, editing still images, effect, titles, and combinations thereof).

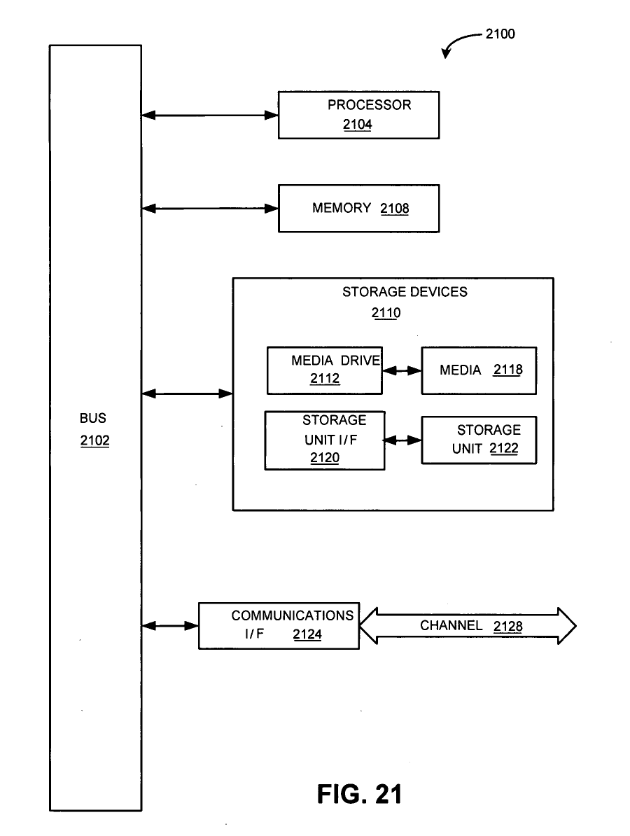

FIG. 21 illustrates an exemplary computing system 2100 that may be employed to implement processing functionality for various aspects of the invention (e.g., as a user device, web server, media asset library, activity data logic/database, etc.). Those skilled in the relevant art will also recognize how to implement the invention using other computer systems or architectures. Computing system 2100 may represent, for example, a user device such as a desktop, mobile phone, personal entertainment device, DVR, and so on, a mainframe, server, or any other type of special or general purpose computing device as may be desirable or appropriate for a given application or environment. Computing system 2100 can include one or more processors, such as a processor 2104. Processor 2104 can be implemented using a general or special purpose processing engine such as, for example, a microprocessor, microcontroller or other control logic. In this example, processor 2104 is connected to a bus 2102 or other communication medium.

Computing system 2100 can also include a main memory 2108, preferably random access memory (RAM) or other dynamic memory, for storing information and instructions to be executed by processor 2104. Main memory 2108 also may be used for storing temporary variables or other intermediate information during execution of instructions to be executed by processor 2104. Computing system 2100 may likewise include a read only memory (“ROM”) or other static storage device coupled to bus 2102 for storing static information and instructions for processor 2104.

The computing system 2100 may also include information storage mechanism 2110, which may include, for example, a media drive 2112 and a removable storage interface 2120. The media drive 2112 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 2118 may include, for example, a hard disk, floppy disk, magnetic tape, optical disk, CD or DVD, or other fixed or removable medium that is read by and written to by media drive 2114. As these examples illustrate, the storage media 2118 may include a computer-readable storage medium having stored therein particular computer software or data.

In alternative embodiments, information storage mechanism 2110 may include other similar instrumentalities for allowing computer programs or other instructions or data to be loaded into computing system 2100. Such instrumentalities may include, for example, a removable storage unit 2122 and an interface 2120, such as a program cartridge and cartridge interface, a removable memory (for example, a flash memory or other removable memory module) and memory slot, and other removable storage units 2122 and interfaces 2120 that allow software and data to be transferred from the removable storage unit 2118 to computing system 2100.

Computing system 2100 can also include a communications interface 2124. Communications interface 2124 can be used to allow software and data to be transferred between computing system 2100 and external devices. Examples of communications interface 2124 can include a modem, a network interface (such as an Ethernet or other NIC card), a communications port (such as for example, a USB port), a PCMCIA slot and card, etc. Software and data transferred via communications interface 2124 are in the form of signals which can be electronic, electromagnetic, optical, or other signals capable of being received by communications interface 2124. These signals are provided to communications interface 2124 via a channel 2128. This channel 2128 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 2108, storage device 2118, storage unit 2122, or signal(s) on channel 2128. These and other forms of computer-readable media may be involved in providing one or more sequences of one or more instructions to processor 2104 for execution. Such instructions, generally referred to as “computer program code” (which may be grouped in the form of computer programs or other groupings), when executed, enable the computing system 2100 to perform features or functions of embodiments of the present invention.

In an embodiment where the elements are implemented using software, the software may be stored in a computer-readable medium and loaded into computing system 2100 using, for example, removable storage drive 2114, drive 2112 or communications interface 2124. The control logic (in this example, software instructions or computer program code), when executed by the processor 2104, causes the processor 2104 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. An interface for editing media assets, the interface comprising:
a display for displaying a plurality of tiles, each tile associated with a media asset; and
a timeline for displaying relative times of each of the plurality of media assets as edited by a user for an aggregate media asset, the timeline automatically adjusting in response to edits to the media assets.

2. The interface of claim 1, further comprising a display for displaying the plurality of media assets.

3. The interface of claim 1, wherein the timeline further concatenates in response to edits of the media assets.

4. The apparatus of claim 1, wherein the timeline maintains a fixed length when adjusting in response to edits of the media assets.

5. The interface of claim 1, wherein edits instructions are generated based, in part, on the display the plurality of tiles.

6. The interface of claim 5, wherein a change in order of the tiles changes the edit instructions.

7. The interface of claim 5, wherein an addition or deletion of a tile changes the edit instructions.

8. The apparatus of claim 1, further comprising a search portion operable to search for media assets.

9. The apparatus of claim 1, further comprising displaying an effect associated with one of the plurality of media assets, the effect remaining with the media asset in response to a change in the displayed timeline.

10. Apparatus for displaying an interface for editing media assets, the apparatus comprising:
logic for causing a display of a timeline indicating relative times associated with each of a plurality of media assets as edited by edit instructions, the timeline automatically adjusting in response to a change to the edit instructions.

11. The apparatus of claim 10, further comprising logic for displaying a display portion for displaying a tile associated with each of the plurality of media asset and a display portion for displaying the media assets according to the edit instructions.

12. The apparatus of claim 11, wherein the edit instructions change in response to a change in the display of the plurality of tiles.

13. The apparatus of claim 11, wherein a change in an order of the tiles changes the edit instructions.

14. The apparatus of claim 11, wherein an addition or deletion of a tile changes the edit instructions.

15. The apparatus of claim 10, wherein the timeline maintains a fixed length when adjusting in response to a change in the edit instructions.

16. The apparatus of claim 10, wherein the timeline automatically concatenates in response to changes.

17. An interface for editing media assets, the interface comprising:
a tile display for displaying a plurality of tiles, each tile associated with at least a portion of a media asset;
a display for displaying media assets associated with the plurality of tiles; and
a search interface for searching for additional media assets.

18. The interface of claim 17, wherein the search comprises a search of remote media assets.

19. The interface of claim 17, wherein the search comprises an Internet search.

20. The interface of claim 17, wherein the search comprises a search of local media assets.

21. The interface of claim 17, wherein a media asset is received in response to a selection within the search interface.

22. The interface of claim 17, wherein a new tile is displayed in the tile display in response to a selection of a media asset in the search interface.

23. A method for editing media assets and generating an aggregate media asset, the method comprising:
displaying a timeline indicating relative times of a plurality of media assets as edited for an aggregate media asset; and
adjusting the display of the timeline in response to changes to edits of the plurality of media assets.

24. The method of claim 23, wherein the timeline maintains a fixed length as the timeline is adjusted.

25. The method of claim 23, further comprising concatenating the timeline in response to an edit of the media assets.

26. The method of claim 23, further comprising generating edit instructions based on the edits of the plurality of media assets.

27. The method of claim 23, further comprising displaying a tile associated with each of the plurality of media assets, wherein changes in the tiles results in changes to the timeline.

28. The method of claim 23, further comprising displaying the aggregate media asset as edited.

29. The method of claim 23, further comprising displaying a search interface for searching for media assets.

30. A computer-readable medium comprising instructions for editing media assets and generating an aggregate media asset, the instructions for causing the performance of the method comprising:
displaying a timeline indicating relative times of a plurality of media assets as edited for an aggregate media asset;
adjusting the display of the timeline in response to changes to edits of the plurality of media assets.

31. The computer-readable medium of claim 30, wherein the timeline maintains a fixed length as the timeline is adjusted.

32. The computer-readable medium of claim 30, the method further comprising concatenating the timeline in response to an edit of the media assets.

33. The computer-readable medium of claim 30, the method further comprising generating an edit instruction based on the edits of the plurality of media assets.

34. The computer-readable medium of claim 30, the method further comprising displaying a tile associated with each of the plurality of media assets, wherein changes in the tiles results in changes to the timeline.

35. The computer-readable medium of claim 30, the method further comprising displaying the aggregate media asset.

36. The computer-readable medium of claim 30, the method further comprising displaying a search interface for searching for media assets.
